(19) United States
(12) Patent Application Publication
(10) Pub. No.: US 2008/0167999 A1
(43) Pub. Date: Jul. 10, 2008

(54) Methods of Selling and Issuing Loan-Backed Investment Certificates Providing for Interest-Only Payments Until, and Principal Repayment at, Maturity

(76) Inventor: Nancy G. Morazan, Baton Rouge, LA (US)

Correspondence Address: McGLINCHEY STAFFORD, PLLC, 4703 BLUEBONNET BLVD, BATON ROUGE, LA, 70809, US

(21) Appl. No.: 10/556,275

(22) PCT Filed: May 13, 2004
(86) PCT No.: PCT/US2004/015143

§ 371 Date: Apr. 3, 2008

Related U.S. Application Data
(60) Provisional application No. 60/470,023, filed on May 13, 2003.
(60) Provisional application No. 60/492,880, filed on Aug. 6, 2003.

(51) Int. Cl. G06Q 40/00

(52) U.S. Cl. 705/36 R; 705/35

(57) ABSTRACT

A method carried out by selling one or more investment certificates in exchange for consideration, wherein each of the investment certificates represents a transferable right secured by at least one first pool of documented, monetary obligations, and wherein each of the investment certificates is at least characterized as follows: (i) when first sold, the certificate is sold to at least one purchaser for a principal amount of consideration, and (ii) the certificate includes commitments from an issuer of the certificate to repay the principal amount of consideration to the at least one purchaser, or a permitted transferee of the at least one purchaser, only upon the occurrence of a fixed maturity date and to make periodic payments of interest only from a selected date until the fixed maturity date, which interest accrues upon the principal amount of consideration at an interest rate specified when the certificate is first sold. In one embodiment, the method further includes the step of managing the at least one first pool of documented, monetary obligations to maintain a cash flow generated by the pool(s) sufficiently to provide at least enough cash to enable the payment of all interest payments and the principal amount of money due under the investment certificates to the purchasers thereof.

### REFERENCE TO RELATED APPLICATIONS

This application claims the benefit of U.S. Provisional Application 60/492,880 filed on Aug. 6, 2003, and U.S. Provisional Application 60/470,023, filed on May 13, 2003, the disclosures of which are incorporated herein by reference.

### FIELD OF THE INVENTION

The present invention is related to methods of selling and issuing loan-backed investments to the general public and public and private investors.

### BACKGROUND OF THE INVENTION

Many investors desire to invest a fixed amount of capital for as short a period of time as one, six or twelve months to as much time as ten, twenty or more years at a fixed rate of interest, and to leave all capital invested until the end of the term of the investment. These investors also seek an investment which is readily and easily sold in the marketplace, should they desire to convert their investment to cash. Elderly investors in particular seek such investments.

The United States provides investments in the form of United States Treasury Bills, Notes and Bonds to the public. Treasury Bills are issued for one year or less, are sold at a discount from their face value and do not pay interest before maturity. The difference between the purchase price of the bill and the amount paid at maturity or at sale, if disposed of prior to maturity, is the interest earned. Treasury Notes, which have a term of more than one year but less than ten years, bear a stated interest rate and the purchaser receives semi-annual interest payments. Treasury Bonds, which have a term of more than ten years, bear a stated interest rate and the purchaser receives semi-annual interest payments.

There are two kinds of Notes and Bonds: Fixed Principal and Inflation-Indexed. With inflation-indexed notes and bonds the semi-annual interest payments and maturity payment are calculated on the basis of the inflation-adjusted principal value of the security. The Treasury Department has not offered a Treasury Bond since October, 2001.

Other U.S. Government Bonds, also called agency bonds, are issued by federal agencies and are not full-faith-and-credit obligations of the U.S. Government. Fannie Mae (Federal National Mortgage Association) and Ginnie Mae (Government National Mortgage Association) are the main issuers of agency bonds. They are different from the mortgage-backed securities issued by those agencies and by Freddie Mac (Federal Home Loan Mortgage Corporation), which is also a GSE (government sponsored enterprise).

Mortgage-backed securities are available which pay interest at a fixed rate and principal back over a fixed period of time. Such mortgage-backed securities provide the owner with the incremental return of capital and interest during the term of the security, and the owner cannot leave all of the invested capital in the security during the term of the security. Additionally, unexpected receipts of principal, due to loans being paid in full, borrowers paying additional principal with their regular payments, and foreclosures, are passed through to certificate holders upon receipt.

Virtually every mortgage-backed or loan-backed investment opportunity which issues loan-backed certificates, bonds, participations or collateralized mortgage obligations either monthly, quarterly, semi-annually or annually reduces the investment of the holder to align the issue with the collateral remaining in the portfolio. When portfolio cash flows are accelerated, e.g., through early payoffs, the collateral value drops and the unexpected receipts are distributed to the investors are payback of principal. This scenario typically substantially reduces the investor's expected return on investment and shifts all of the risk of collateral liquidation on the investor.

Systems related to managing securities are known in the art. However, the management of these securities is customarily limited to assuring that distributions of principal and interest are passed on to those individuals and entities which have invested in the securities. Exemplary of the patents and published patent applications of the related art are the following: U.S. Pat. Nos. 6,070,151; 6,345,262; U.S. Patent Application Publications Number US 2002/0103750 A1 Published Aug. 1, 2002 by Herzfeld; US 2002/0161690 A1 Published Oct. 31, 2002 by McCarthy et al.; US 2002/0174046 A1 Published Nov. 21, 2002 by Mistretta; and US 2002/0198812 A1 Published Dec. 26, 2002 by Wizon et al.

### SUMMARY OF THE INVENTION

The present invention provides, amongst other things, loan-backed investment certificates, which may be made available to the general public, having a term of from one month to forty or more years. The certificates pay interest-only monthly at a fixed rate for the full term of the investment with the full return of the investment and final interest payment at the end of the scheduled investment term.

The present invention also provides a system for preparing and managing a portfolio of loans providing collateral for loan-backed investment certificates which substitutes and/or supplements a loan or loans, in whole or in part, for loans in the portfolio which become non-performing on a cash flow basis for one reason or another (e.g., are paid in full unexpectedly, experience curtailments of principal or are foreclosed, modified, or are delinquent due to bankruptcy), requiring their removal from the portfolio of collateral. Thus, in this context, “non-performing” may not necessarily mean that a loan is in default, but rather may simply be paid off or otherwise fails to generate the stream of cash flow anticipated in accordance with the loan terms. “Curtailments” as used herein refer to payments on a loan made timely but in an amount in excess of the required amount Whether a curtailment in a single loan causes that loan to become non-performing will depend upon the cash flow requirements and characteristics of a given pool of loans.

One of the unique aspects of certain embodiments of the present invention is the monthly alignment of the loan portfolio cashflow with the payments being made under the issued, loan-backed investment certificates while providing a mechanism for supplementing and augmenting the loan portfolio to assure that the cash-flow generating collateral in the portfolio is sufficient to support the issuer's payment obligations through to maturity of the respective issued loan-backed investment certificates. In certain embodiments of the present invention, this alignment is carried out using a pro-active, participatory methodology designed to create, as well as to manage, a portfolio of loans for the purpose of issuing a plurality of loan-backed investment certificates having a variety of interest rates and maturities, where the owners of the investment certificates are not subjected to rapid principal paydown prior to maturity, and are thereby subjected to a lower risk of reduction in their investment's overall rate of return. This is accomplished by reinvesting liquidated portfolio collateral proceeds in replacement collateral in the form of one or more cash-flow generating loans which meet the pre-determined criteria for that portfolio.

Thus, in one particular embodiment, the present invention provides a method comprising selling one or more investment certificates in exchange for consideration, wherein each of the investment certificates represents a transferable right secured by at least one first pool of documented, monetary obligations, and wherein each of the investment certificates is at least characterized as follows: (i) when first sold, the certificate is sold to at least one purchaser for a principal amount of consideration, and (ii) the certificate includes commitments from an issuer of the certificate to repay the principal amount of consideration to the at least one purchaser, or a permitted transferee of the at least one purchaser, only upon the occurrence of a fixed maturity date and to make periodic payments of interest only from a selected date until the fixed maturity date, which interest accrues upon the principal amount of consideration at an interest rate specified when the certificate is first sold. In another embodiment the method further comprises the step of managing the at least one first pool of documented, monetary obligations to maintain a cash flow generated by the pool(s) sufficiently to provide at least enough cash to enable the payment of all interest payments and the principal amount of money due under the investment certificates to the purchasers thereof. In yet another embodiment of the invention, the step of managing the at least one first pool is carried out by a process comprising categorizing the cash flow stream of each documented obligation within the first pool(s) relative to all of the other documented obligations within the first pool(s), removing from the first pool(s) all obligations within the first pool(s) which become non-performing on a cash flow basis, and, for each non-performing monetary obligation removed from the first pool(s), substituting a substitute documented, monetary obligation which is of like kind to that of the respective non-performing monetary obligation at a time prior to non-performance, wherein the substitute monetary obligation when so substituted provides a cash flow stream at the time of substitution substantially equal to or greater than that of the non-performing obligation for which it is a substitute. The step of managing may, in other embodiments, further comprise establishing a secondary pool of like kind, documented, monetary obligations from income derived from the first pool(s) so as to provide a ready source for substitute documented, monetary obligations.

In still another embodiment of the invention there is provided a method comprising issuing one or more investment certificates to be sold to one or more purchasers, wherein each of the investment certificates represents a transferable right secured by at least one first pool of documented, monetary obligations. Each of the investment certificates is at least characterized as follows: (i) when first sold, the certificate is sold to at least one purchaser for a principal amount of consideration, and (ii) the certificate includes commitments from the issuer of the certificate to repay the principal amount of consideration to the at least one purchaser, or a permitted transferee of the at least one purchaser, only upon the occurrence of a fixed maturity date and to make periodic payments of interest only from a selected date until the fixed maturity date, which interest accrues upon the principal amount of consideration at an interest rate specified when the certificate is first sold.

In yet another embodiment of this invention, the step of managing further comprises borrowing principal from the funds generated by a separate issuance of one or more investment certificates of this invention; wherein the borrowing is consummated in a sufficient amount so as to insure that the issuer can meet its monetary obligations when one or more of the substituted, documented obligations bears interest at a rate lower than that of the respective non-performing monetary obligations for which they serve as a substitute.

These and other embodiments, features and advantages of the present invention shall now be further appreciated from the following detailed description and the appended claims.

### BRIEF DESCRIPTION OF THE DRAWINGS

FIG. 1 is an outline of one embodiment of the present invention for creating loan-backed investment certificates and managing the pool of loans which serve as collateral backing those certificates.

FIG. 2 is a block diagram of the loan mapping, amortization and certificate stratification employed when practicing the embodiment of the present invention outlined in FIG. 1.

FIG. 3 is a block diagram of the cash management step employed in the embodiment of the present invention outlined in FIG. 1.

FIG. 4 is a block diagram of the data management step employed in the embodiment of the present invention outlined in FIG. 1.

### BRIEF DESCRIPTION OF THE TABLES

Tables 1-3 are included near the end of the Detailed Description on the Invention to provide exemplary numbers from a example of the embodiment of the invention outlined in the Figures. The tables include portions of reports, spreadsheets and calculations performed in an example of the application of the above-referenced embodiment of the invention in the preparation and management of a loan portfolio managed and used in accordance with this invention to provide collateral for investment certificates created in accordance with the invention. Thus:

Table 1 is a spreadsheet (also referred to herein as the “Loan Mapping Module”) of the loans being reviewed in ascending term order, followed by the term summary. For brevity, the first 3 loans and the last 3 loans of the ascending term map (1710 total loans in actual example) are followed by the first year of the term summary. It should be understood that, when used in this description, the term “Module” refers to a database.

Table 2 is an amortization spreadsheet (also referred to as the “Amortizing Program Module”) produced in the practice of this particular embodiment of this invention. For brevity, the first 3 loans and the last 3 loans (1710 total loans in actual example) of Year 1 and the 4 remaining loans of Year 16 are included. Because of the number of columns in Table 2, it has been broken into several sub-tables in order to accommodate the dimensional limitations of the pages of this disclosure.

Table 3 is another spreadsheet (also referred to as the “Certificate Stratification Module”) produced in the practice of this particular embodiment of this invention to show the funding and timing of a group of issued investment certificates over time. For brevity, months 1 through 26 and months 173 through 181 of Year 1 and the remaining month of Year 16 are included. Again, because of the number of columns in Table 3, it has been broken into several sub-tables in order to accommodate the dimensional limitations of the pages of this disclosure.

### DETAILED DESCRIPTION OF THE INVENTION

The present invention enables investors to purchase investment certificates which provide a fixed rate of return, while providing numerous choices with respect to the rate of return and the term of the investment. This is accomplished typically by issuing a plurality of certificates having different rates of return and different terms to maturity. These different rates of return and maturity dates are provided through an alignment of the certificate payment schedules and maturities with the cash flow provided by the cash-flow generating documented, monetary obligations backing the certificates, namely, the pool of loans. The integrity of the issue is insured through a proactive approach to managing the pool of collateral backing the certificates which maintains the level of cash flow generated by the pooled collateral. These concepts will now be illustrated through a specific example of one embodiment of the invention.

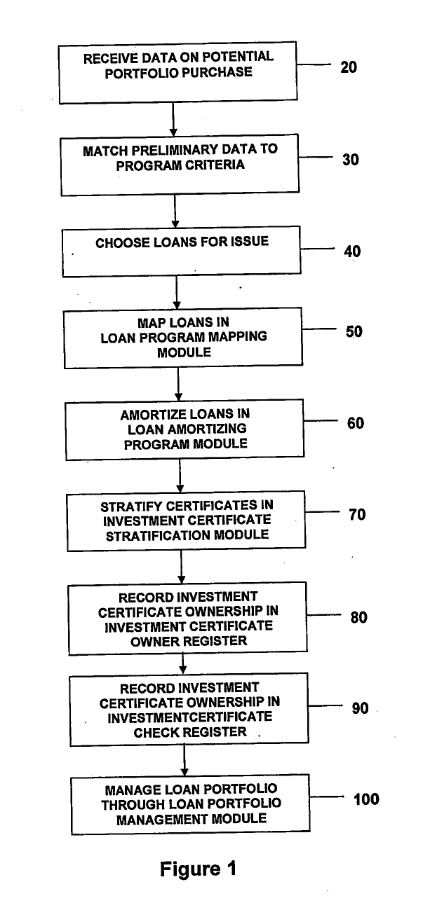

Referring now to the drawings, an embodiment of this invention is outlined in FIG. 1. The system outlined is a pro-active, participatory system designed to create, as well as to manage, a portfolio of loans for the purpose of issuing loan-backed investment certificates having a variety of interest rates and maturities. The system of this embodiment of the invention may issue investment certificates which aggregate less than one hundred percent of the outstanding balances of the portfolio of loans providing collateral for the investment certificates issued in accordance with the invention. The issued amount could vary from 125% or more of the collateral to less than 1% of the collateral. A typical issue might preferably be in the range of 95% to 99% of the collateral. The issuer of the investment certificates, created in accordance with such a preferred issue range of the invention, may have an ownership interest in the issue of between 1% and 5%, thereby over-collateralizing the original issue. This over-collateralization of the original issue inures to the benefit of both the owners of the loan-backed investment certificates issued in accordance with the invention and the issuer of the loan-backed investment certificates by assuring that there are sufficient funds for payment of the amounts due to the owners of the investment certificates each month and at maturity. The purchasers/owners of the loan-backed investment certificates of the invention will not share in the over-collateralization or in any income or monetary benefits it produces other than additional security for performance of the obligation of the issuer to the investment certificate purchaser/owner.

Each of the specific process steps of the illustrated embodiment of this invention now will be discussed in detail.

### Receive Data on Potential Portfolio Purchase

The first step in a preferred system of the invention outlined in FIG. 1 generally indicated by the numeral 20 is to “Receive Data on Potential Portfolio Purchase”, the term “data” referring to various information about loans to be included in the loan portfolio 42.

The data received for review will typically be presented in a spreadsheet or database format All spreadsheets employed in example shown in the Tables 1-3 of one embodiment of the invention use the conventional Microsoft® Excel® spreadsheet well known in the art and the formulas embedded within Microsoft® Excel® 2000. This spreadsheet is available from Microsoft Corporation, Microsoft PacWest Offices, Civic Office Building, 205 108th Avenue, NE, Suite 400, Bellevue, Wash. 98004, through its nationwide distributors, as well as at most computer retail outlets. If the data received is in any other format, it is exported or input into a loan review spreadsheet with all information intact. If desired, other spreadsheets and databases, including relational databases, known in the art may be used to facilitate the handling of the data involved and to facilitate making the calculations which may be desired to facilitate use of the system.

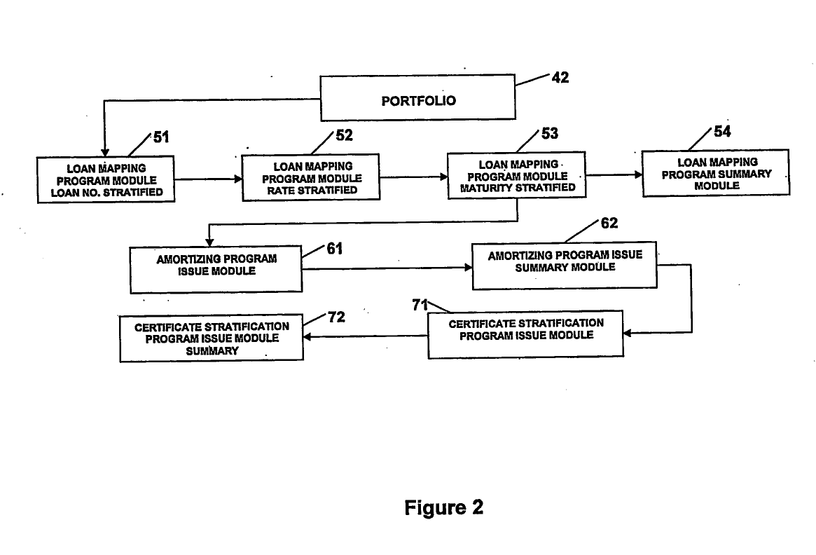

The issuer of the loan-backed investment certificates of the invention in accordance with this embodiment receives various packages of loan portfolios for review in its efforts to locate portfolios of loans which meet the criteria for being included in portfolio 42 of loans shown in FIG. 2 collateralizing the issued investment certificates of the invention. The issuer of the loan-backed investment certificates of the invention may be, but is not limited to, a bank, mortgage company, credit union, investment banker, private investment firm or a securities investment entity or dealer. A list of predetermined criteria may be established and maintained by the Issuer and disseminated to sellers of loan portfolios to facilitate this process. This list can be adjusted, changed and updated periodically, e.g., at least monthly, by the Issuer to take into consideration changes in the market and new types of loan products available for purchase.

Each loan to be included in the portfolio 42 shown in FIG. 2 of loans providing collateral for the investment certificates issued in accordance with this embodiment of the invention should undergo an extensive review process to assess all of the characteristics corresponding to the pre-determined criteria for each individual loan. Pre-determined loan criteria established by the issuer include, but are not limited to, interest rate, term, balance, maturity, loan type, and payment history, including in some cases minimum or maximum values. Each loan to be included in portfolio 42 securing each investment certificate of the invention must meet or exceed the predetermined criteria set out for each investment certificate issue by the issuer of the investment certificates. The selection of specific values for the pre-determined criteria will be assessed and determined on an issue-by-issue and issuer-by-issuer basis, depending upon the risk profile of the issuer and the field of potential investors.

The issuer also may originate loans for its own portfolio and for inclusion in portfolio 42 and may add its loans, together with the loans being reviewed for purchase, to create portfolio 42. Additionally, the Issuer may combine various loan packages from various sellers, as well as from its own portfolio, to create portfolio 42.

The issuer of the investment certificates of the invention may accept loan packages where the seller conveys its right to service the loans to the issuer or may accept loan packages where the seller continues to service the loans in the portfolio 42 of loans collateralizing the investment certificates issued in accordance with the invention. In the specific example illustrated, the issuer has addressed the service fee payment in its Module 60 of FIG. 1, Module 61 of FIG. 2 to calculate net interest received after payment of the servicing fee, if any, to the loan servicer.

The issuer preferably has a loan servicing software program, purchased from and maintained by a third party vendor. The loan servicing software allows the issuer to service loans for its own portfolio, service loans in the Auxiliary/General Loan Portfolio (the portfolio of loans the issuer owns and has set aside to supplement the Issued Portfolio) and service loans for the portfolio 42 of loans collateralizing the issued investment certificates of the invention, and to “master” service other portfolios serviced directly by other lenders or servicers from whom it has purchased loans to be included in the portfolio 42 of loans collateralizing the issued investment certificates of the invention and from whom it receives funds collected with related data.

The master servicing element of its servicing software program allows the issuer to receive, from other loan servicers of portions of the issued portfolio, monthly data manually, electronically, or on a storage medium and to use this data to update its records on the portfolio 42 of loans collateralizing the investment certificates issued in accordance with the invention as part of its monthly reporting and portfolio balancing procedures.

The data is industry standard well known in the art and includes all payment information on every loan, showing receipts of regular payments, prepaid payments, delinquent payments, curtailments, paid in full loans and loans removed for foreclosure. It also supplies data on changes in adjustable rate loans and changes in loans for loan modification.

The portfolio 42 of loans collateralizing the issued investment certificates of the invention is unique in that it combines loans of varying interest rates with diverse repayment plans having short, intermediate and long term maturities into a market sensitive participation opportunity with varying maturities which is managed to overcome the usual unexpected principal returns found in other loan-backed investment offerings which occur when loans are paid in full, experience curtailments of principal or are removed for foreclosure, loan modification or excessive delinquency due to bankruptcy.

The issuer may also maintain and supplement a General Loan Portfolio through use of an auxiliary pool of loans (referred sometimes herein as an Auxiliary Loan Portfolio) from which to draw substitute loans, in whole or in part, to replace loans removed from portfolio 42 through payoff and/or foreclosure, as well as to supplement additional principal payments occurring in the General Loan Portfolio not previously anticipated.

The basic loan to be included in the portfolio 42 of loans collateralizing the issued investment certificates of the invention may be a Conventional, VA, FHA, RDUSDA, SBA loan, Balloon loan or Graduated Payment Loan. It may be a first mortgage, a second mortgage or subordinate lien or a home equity loan/home equity line of credit and can be fixed rate or adjustable rate. The loan may be a fixed/adjustable (fixed for a certain period, then adjustable for its remaining term). The loan may be amortizing interest or simple interest. The loan may be interest only for a period of time, followed by a period of principal and interest which will amortize the loan balance.

Although mortgage loans or mortgage obligations offer the most compatible and most easily managed portfolio types, the portfolio 42 of loans collateralizing the issued investment certificates of the invention can utilize any type of documented loan, including but not limited to, vehicle loans, boat loans, secured and unsecured signature loans, multi-family loans, student loans, commercial real estate loans, commercial or business loans, and retail credit obligations, as well as credit card and credit line loans. Preferably, the loans within a given pool backing an issue will be of like kind, meaning that the loans will be collateralized, if at all, with similar types of collateral.

The collateral backing the issue may include, but is not limited to, the excess interest generated during the life of the issue. Additionally, the collateral backing the issue may also include, but is not limited to, securities, government obligations, agency bonds, corporate bonds, municipal bonds, mortgage backed securities, collateral mortgage obligations, foreclosures, factored receivables, real estate owned properties, stocks, contracts, guarantees, escrows, insurance settlements, leases, liens, encumbrances, leaseholds, judgments, charge-offs, grants, past, present and future receivables, present and future dividends. Virtually any other asset may also be used as the collateral as long as the asset can otherwise be pledged to secure the repayment of an obligation.

The loans may be newly originated (the borrower having paid no payments) or at any stage prior to maturity, e.g., 29 years 11 months old on 30 year loans, or 34 years 11 months for 35 year loans. In the case of home equity loans and home equity lines, there may be a period of interest only followed by a period of principal and interest to pay the loan in full at a specified maturity.

The information received for review may include a loan number or identification number, a product type, a loan type, a loan date, due date of the first payment, maturity date, original interest rate, present interest rate, index, margin, next change date, rate cap, rate floor, rate ceiling, original appraised amount, an original loan amount, an original line amount (home equity loan/line), a loan-to-value ratio, an additional draw amount, draw period and repayment period (home equity loan/line), a present loan balance, a next due date, an interest paid to date, an interest accrued amount, a monthly principal and interest amount, an interest only amount, a term, a draw term and repayment term (home equity loan/line), an original FICO (Fair Isaac Corporation method of scoring credit records) credit score, a current FICO credit score, a payment history which may include number of times 30, 60, 90 days late, and City, State and Zip Code.

The loans should all have the same next due date; however, the portfolio 42 of loans collateralizing the issued investment certificates of the invention, depending on its criteria, may accept rolling 30, 60, 90 day forward (consistently paid ahead 30, 60 or 90 days) or backward (consistently paid late 30, 60 or 90 days) loans, as well as odd due date (payment due on other than the first of the month) loans.

If, for example, the next payment on each loan is due Oct. 1, 2002, the beginning/remaining principal balance would be the balance after the Sep. 1, 2002 payment was applied. On an odd due date payment such as a loan due Sep. 23, 2002, the beginning/remaining principal balance would be the balance after the Aug. 23, 2002 payment The remaining principal balance on every loan which would have been mapped on an amortization schedule and then exported to the Module 60 of FIG. 1, Module 61 of FIG. 2 would have been the balance after application of the Sep. 1, 2002 payment. Module 60 of FIG. 1 and Module 61 of FIG. 2 would then schedule payments beginning Oct. 1, 2002 and would end on each particular loan at the maturity/zero balance of that loan.

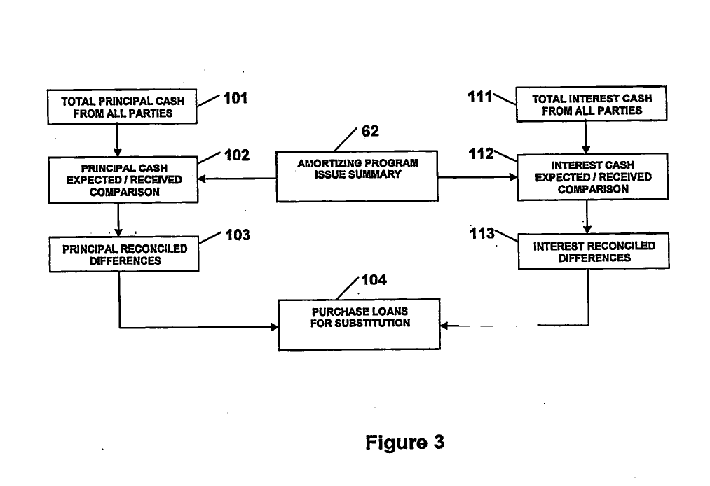

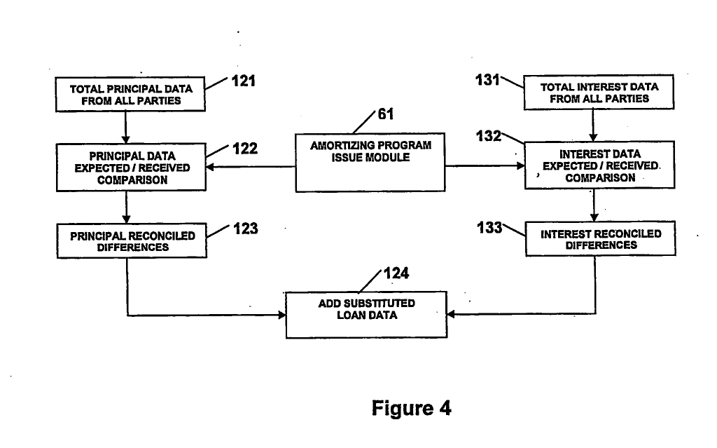

When Adjustable Rate Loans (ARM loans) are included in the portfolio 42, a decision must be made at this point in the review regarding the investment certificates of the invention to be issued. When individual ARM loans have a floor rate which is equal to or greater than the highest anticipated rate of the last investment certificate issued, after deducting servicing fees, if any, the ARM loan may be treated as though it were a fixed rate loan. As its rate increases and decreases, the change is adjusted in Module 60 of FIG. 1, Module 61 of FIG. 2 and in the Amortizing Program Issue Summary Module 62 of FIG. 2. The Cash Management Reconciliation in FIG. 3 and the Data Management Reconciliation in FIG. 4 are then adjusted to reflect rate changes and rate increases/decreases.

When an ARM loan amortizes earlier than the last investment certificate to be issued and its floor rate or index rate (lowest historical rate) plus margin less applicable servicing fee, if any, is equal to or greater than the highest anticipated rate of the last investment certificate issued at the ARM loan maturity, the ARM loan may be treated as though it were a fixed rate loan. As its rate increases and decreases, the change is adjusted in Module 61 of FIG. 2 and in Module 62, the Cash Management Reconciliation FIG. 3 and the Data Management Reconciliation FIG. 4.

When ARM loans make up a large portion of the portfolio 42 of loans collateralizing the issued investment certificates of the invention, the investment certificates of the invention may be issued as adjustable rate investment certificates and will adjust after the first complete issue year. This requires that the Loan Program Mapping Module 50 shown in FIG. 1 be augmented each month, to record the changes in the index and the corresponding loan rate on individual loans. Changes to the index may change the rate of the investment certificates issued and the portfolio 42 of loans collateralizing the issued investment certificates would be adjusted in Module 70 of FIG. 1, as well as the Amortizing Program Summary Module 62 shown in FIG. 2, to reflect the rate adjustments to individual loans. The Cash Management Reconciliation FIG. 3 and the Data Management Reconciliation FIG. 4 would be adjusted to reflect the interest rate increase/decrease.

As stated above, the data received for review should be in a spreadsheet format. All spreadsheets employed in the invention use the Microsoft® Excel® Spreadsheet and the formulas embedded within Microsoft® ExcelS 2000. This spreadsheet is available from Microsoft Corporation, Microsoft PacWest Offices, Civic Office Building, 205 108th Avenue, NE, Suite 400, Bellevue, Wash. 98004, through its nationwide distributors, as well as at most computer retail outlets. If the data received is in any other format, it is exported or input into a Loan Review Spreadsheet with all information intact.

### Match Preliminary Data to Program Criteria

The next step in a preferred system of the invention outlined FIG. 1 generally indicated by the numeral 30 is to “Match Preliminary Data to Program Criteria”.

The Loan Review Spreadsheet is then sorted by the payment history of 30, 60, 90 days late. Loans which do not meet the selected criteria for inclusion in the portfolio 42 of loans collateralizing the issued investment certificates are moved to a rejected loan spreadsheet, and the reason for rejection is noted. The loans remaining in the loan review spreadsheet meet or exceed the desired payment history criteria.

The system of the invention has the ability to accept rolling 30, 60, 90 forward (consistently paid ahead 30, 60 or 90 days) and backward (paid consistently 30, 60 or 90 days delinquent) payment loan offerings. The program may accept odd due date loans.

The Loan Review Spreadsheet is sorted by FICO credit score. Loans which do not meet the criteria for inclusion in the portfolio 42 of loans collateralizing the issued investment certificates of the invention are moved to a rejected loan spreadsheet, and the reason for rejection is noted. The loans remaining in the Loan Review Spreadsheet meet or exceed the desired Credit Score criteria.

The Loan Review Spreadsheet is then sorted by LTV, (loan-to-value ratio). Loans which do not meet the criteria for inclusion in the portfolio 42 of loans collateralizing the issued investment certificates of the invention are moved to a rejected loan spreadsheet, and the reason for rejection is noted. The loans remaining in the loan review spreadsheet meet or exceed the desired LTV criteria.

The Loan Review Spreadsheet is then sorted by due date to identify both loans which may be delinquent and loans which may be paid in advance. As most loans which are delinquent or are prepaid do not significantly impact the amount of principal and interest collections, loans which are rolling 30, 60 or 90 days forward and backward have little or no effect on the overall amount of funds expected or collected. If it is part of the selection criteria to include such loans, the loan history is reviewed to assure that the prepaid loan is consistently prepaid and the delinquent loan is consistently delinquent over at least a one year period.

For example, a rolling 90 forward loan would apply when a loan is due for Jan. 1, 2003 and the anticipated portfolio 42 of loans collateralizing the issued investment certificates of the invention would begin with loans due for Oct. 1, 2002. Thus, when a particular loan is consistently paid 90 days (3 monthly payments) ahead, the loan can be treated as though it is due for Oct. 1, 2002 and all of its remaining payments are used in the portfolio 42. If the payment is skipped one month and the loan is no longer 90 days ahead, it may represent a timing situation but does not affect the amount of finds anticipated over the remaining life of the loan. Prior to inclusion in the portfolio 42 of loans collateralizing the issued investment certificates of the invention the loan history would be reviewed, and, at least, the last 12 payments would have to have been 90 days ahead. Rolling 30 day or rolling 60 day forward payments would be treated exactly the same as the rolling 90 day forward loan example above.

This situation may apply to a rolling 30 day backward payment loan where the loan has consistently been 30 days delinquent over the past 12 months. It would be treated in the same manner as the rolling 90 day forward loan example. While this provides an additional option not found in other mortgage backed investment opportunities, its inclusion here does not indicate that this loan situation will be found in any portfolio 42 of loans collateralizing the issued investment certificates of the invention. It merely exemplifies the flexibility and diversity in the system of the invention and its ability to incorporate many loans not usually included in mortgage backed investment offerings.

If other factors such as geographic location or loan type will be considered, the Loan Review Spreadsheet is sorted by location or loan type to assure that the loans on the final Loan Review Spreadsheet meet or exceed all preliminary criteria.

The Loan Review Spreadsheet receives a final visual examination to quantify and qualify all information submitted to assure that each detail of every loan was considered and evaluated in relation to the final loan portfolio chosen for the portfolio 42 of loans collateralizing the issued investment certificates of the invention.

The last step in the review of information submitted is to copy the final Loan Review Spreadsheet into a blank spreadsheet with the loans listed or stratified in numerical order and eliminate every item not needed to map the portfolio 42 in the Loan Program Mapping Module 50 of FIG. 1 and the Loan Program Mapping Module Loan No. Stratified 51 of FIG. 2 after the loan calculation review comparison test is completed. This will leave the loans stratified or sorted in numerical order with the present loan balance, the interest rate, the principal and interest payment, and the maturity date of each loan as shown in Table 1.

The loan calculation review consists of using the present loan balance, the interest rate and the principal and interest payment to calculate the remaining term. A spreadsheet may be employed and expanded to use these three factors to create the remaining term in months. This information is compared with the maturity date to locate discrepancies which can result from curtailments (additional principal payments over and above the normal principal included in the regular monthly payment) and from modifications in loan terms, amounts, rates and maturity dates.

A loan which has been modified in amount, rate, term or monthly principal and interest payment may mature earlier or later than its original maturity date. A loan which has had additional principal payments applied during its life will mature earlier than its scheduled maturity. Both scenarios require that the mapped loan be adjusted to take its altered state into consideration when preparing a new portfolio 42 of loans collateralizing the issued investment certificates of the invention.

Loans with sporadic curtailments will not be adjusted prior to their export to the Loan Program Mapping Module 50 of FIG. 1 and Loan Mapping Program Module Loan No. Stratified 51 of FIG. 2. Loans which have a history of regular curtailments in a specific amount will be adjusted to include the regular curtailment in the principal and interest amount and the remaining term is recalculated to reflect this deviation in payment amount. The loan calculation review spreadsheet is then copied to another spreadsheet and the comparison documentation is eliminated, leaving the actual remaining term in months. This loan calculation review spreadsheet now contains the loan number, the current principal balance, the current interest rate, the principal and interest payment and the remaining term in months.

A loan number key is prepared to give each loan a new loan number based upon the identification criteria of the Issuer and the new number is substituted for the previous loan identification.

All of the spreadsheets or other data prepared in the review process typically are stored on conventional removable media and saved for future reference.

### Choose Loans for Issue

The next step in a preferred system of the invention outlined in FIG. 1 generally indicated by the numeral 40 is to “Choose Loans for Issue.” This step is accomplished by exporting the final loan calculation review data, typically in the form of a spreadsheet or database, to Loan Program Mapping Module 50 of FIG. 1 and Loan Mapping Program Module Loan No. Stratified 51 of FIG. 2.

### Map Loans in Loan Program Mapping Module

The next step in a preferred system of the invention outlined in FIG. 1 generally indicated by the numeral 50 is to “Map Loans in Loan Program Mapping Module” and Loan Mapping Program Module Loan No. Stratified 51 of FIG. 2. Each loan in the portfolio 42 providing collateral for the new investment certificates issued is mapped on the Loan Program Mapping Module 50 of FIG. 1 and Loan Mapping Program Module No. Stratified 51 of FIG. 2 to determine its monthly payment spread, its yield in relation to the entire pending new investment certificates issue, and its actual maturity. A loan may mature prior to or after its scheduled maturity, so the scheduled maturity is compared with the actual maturity and discrepancies are researched.

The purpose of the Loan Program Mapping Module 50 of FIG. 1, and Modules 51 through 54 of FIG. 2 exemplified in Table 1, is to sort by categories in ascending or descending order all loan data received from a third party to further examine the strengths and weaknesses of the loans to decide whether or not to include them in portfolio 42 of loans collateralizing the issued investment certificates of the invention. Formulas are used to calculate the annual interest and the remaining loan term in months. A third party provides all other data.

Examples of the loans are listed in Table 1 in the following columns starting left and moving right Loan Number=(In), Outstanding Balance=(b), Annual Interest Rate=(r), Monthly Principal and Interest=(pi), Annual Interest Paid=(i), Term=(t) in months in the Table. Term may be derived using the conventional Microsoft® Excel® function nper which provides the number of periods for an investment based on periodic, constant payments and a constant interest rate. Given Value=(gv)(Value given/submitted by third party or data source):

ln=gv
b=gv
r=gv
pi=gv
I=(b*r)
T=nper(r/12,−pi,b)

Mapping a loan on the Loan Mapping Program Module 50 of FIG. 1, Loan Mapping Program Module Loan No. Stratified 51 of FIG. 2 and Table 1 spreadsheet initially requires a loan number in the first column, outstanding principal balance in the second column, interest rate in the third column, principal and interest payment, plus all researched, identified and verified curtailment amounts expected monthly in the fourth column, and the remaining term in months to actual maturity in the fifth column. Other variations of the organization of the data can be envisioned and could be appropriate to properly analyze the cash flow of the loans under consideration. Thus, Loan Mapping Program Module Maturity Stratified 53 of FIG. 2 can be created using the same loan data to list them by maturity in months, beginning with the loan with the longest remaining term This particular step of loan cash flow analysis is conventional and, for brevity sake, will not be further described herein in detail.

Ultimately, the mapping undertaken provides the data necessary for Loan Amortizing Program Module 60 of FIG. 1 and the Amortizing Program Issue Module 61 of FIG. 2, wherein it is determined precisely how the loans are spread throughout the portfolio 42 by their maturity.

Table 1 sets forth a map of the Loan Program Mapping Module 50 and Loan Mapping Program Summary Module 54 in FIG. 2 by maturity, beginning with the shortest remaining term. Loan Mapping Program Summary Module 54 exemplified in Table 1 is prepared to identify the loan portfolio 42 yields by year as loans mature. The Loan Mapping Program Summary Module 54 exemplified in Table 1 facilitates the setting of rates for the individual investment certificates of the invention by defining the maximum yield by year which will be generated by the underlying loans. This assures that the portfolio 42 of loans collateralizing the issued investment certificates of the invention will adequately cover all interest and principal to be paid to the investment certificate holders during the full term of the portfolio 42, provided that a loan or loans, in whole or in part, are substituted for those loans which are removed or paid down unexpectedly. The loans in the Loan Mapping Program Module Maturity Stratified 53 shown in FIG. 2 are then exported to the Loan Amortizing Program Module 60 in FIG. 1, Amortizing Program Issue Module 61 in FIG. 2.

With reference to Table 1, a composite interest rate (7.75%) is calculated for the Grand Total ($52,939,637.57) which shows the net yield to be expected over the full term of the portfolio 42 of loans collateralizing the issued investment certificates of the invention. This yield can be calculated at any given time during the time spanned by the loan with the longest term. This allows the future yield to be expected at any given time during the life of the portfolio 42 of loans collateralizing the issued investment certificates of the invention to be known and is instrumental in managing the portfolio 42 through loan substitution. When compared with the Certificate Stratification Module 70 of FIG. 1, 71 of FIG. 2 exemplified in Table 3, it gives a clear indication that loans substituted in many cases may be at lesser rates than the removed loan and still not jeopardize the overall integrity of the portfolio 42 of loans collateralizing the issued investment certificates of the invention. Typically, a loan substitution at a lesser rate will reduce the overall yield and will decrease the profit to the Issuer without compromising the funds needed to satisfy the obligations of principal and interest payments to the owners of the investment certificates issued in accordance with the invention. If the loan is at a lesser rate, it reduces the yield to the Issuer, provided that the substituted loan is at a rate which is equal to or greater than the yield of the highest yielding investment certificate of the invention which would mature when the loan removed would have matured. Towards the end of this description, additional steps are described to contend with the rare situation in which the rate drop off for substituted loans is so significant that it may otherwise jeopardize the Issuer's ability to meet the obligations to make payments.

### Amortize Loans in Loan Amortizing Program Module

The next step in a preferred system of the invention is outlined in FIG. 1 generally indicated by the numeral 60 as “Amortize Loans in the Loan Amortizing Program Module”, Amortizing Program Issue Module 61 in FIG. 2 and exemplified in Table 2. The Loan Amortizing Program Module 60, and the Amortizing Program Issue Module 61 in FIG. 2 exemplified in Table 2 uses the mapped loan information from the Loan Program Mapping Module 50 to begin the amortization process. Loan Program Mapping Module 50, and Loan Mapping Program Module Maturity Stratified 53 provides the remaining principal balance, the loan rate, the monthly principal and interest payment (which may include a verified curtailment amount) the monthly interest payment next expected, the service fee rate (if applicable), the service fee amount (if applicable), the net interest expected, the gross principal next expected and the new remaining principal balance after application of the expected principal payment. This process is repeated continuously until every month of the remaining term of the loan is amortized and the final ending balance on each loan is zero.

Loans are exported from the Loan Program Mapping Module 50 of FIG. 1, Loan Mapping Program Module Maturity Stratified 53 of FIG. 2, to the Loan Amortizing Program Module 60 of FIG. 1, the Amortizing Program Issue Module 61 of FIG. 2, both exemplified in Table 2 in order to spread each payment on every loan horizontally from its present principal balance to its maturity with a zero remaining balance.

The loans are imported into the Loan Amortizing Program Module 60, Amortizing Program Issue Module 61, both exemplified in Table 2 after being sorted by the remaining term in months in descending order with the longest term being first. Data is exported from the Loan Program Mapping Module 50, 53 and Table 1 into the Loan Amortizing Program Module 60, Amortizing Program Issue Module 61, exemplified in Table 2 which has been sorted by maturity in descending order with the longest terms first.

Next, each column of the Loan Amortizing Program Module 60, Amortizing Program Issue Module 61, both exemplified in Table 2 is totaled vertically to determine the total amount of net interest and gross principal to be received each month for the entire term of the portfolio 42 of loans collateralizing the issued investment certificates of the invention. This information is then summarized by the Amortizing Program Issue Summary Module 62 of FIG. 2, which summarized data is then exported to the Investment Certificate Stratification Program Module 70 of FIG. 1, Certificate Stratification Program Issue Module 71 of FIG. 2, both exemplified in Table 3.

The Loan Amortizing Program Module 60, Amortizing Program Issue Module 61, both exemplified in Table 2 then becomes the Amortizing Program Base Module. This is the original Module used to amortize the investment certificates of the invention. This Module is copied and the copy will be used as an actual working model (Actual Module). The Amortizing Program Base Module exemplified in Table 2 facilitates the monthly comparison to the Amortizing Program Issue Actual Module which will contain the actual loan changes attributable to borrower payments, borrower non-payments, borrower additional principal payments and borrower loan payoffs, beginning with the first month after issue. This comparison is accomplished using the data generated during the first month and every month thereafter. This comparison allows for loan substitution, in whole or in part, to align the Actual Module to the Base Module and provide for proper portfolio 42 management to assure timely, accurate payment of interest on the investment certificates of the invention monthly and timely, accurate payment of principal on maturing investment certificates of the invention.

Each loan is amortized in row format starting from left and amortized to right. Inserted information includes: Loan Number=(In), Balance=(b), Rate=(r), P&I=(pi), interest=(i), Service Fee Rate=(sr), Service Fee Payable=(sp), Net Interest=(ni), Principal=(pr), New Balance=(nb), Previous New Balance=(pnb), Given Value=(gv) (Value given/submitted by third party or data source), imported (im) or assigned (sg).

### Input for 1 Year.

### Month 1

ln=im
b=im
i=(r*b)/12
sr=gv
sp=i*sr/r
ni=i-sr
pr=pi-i
nb=b-pr
Month 2-12(are repeated)
nb
i=(r*nb)/12
sp=(sr*i)/r
ni=i-sp
pr=pi-i
nb=pnb-pr
In full the row appears as follows:
b1=b-pr, nb2=nb1-pr, nb3=nb2-pr, nb4=nb3-pr, nb5=nb4-pr, nb6=nb5-pr, nb7=nb6-pr, nb8=nb7-pr, nb9=nb8-pr, nb10=nb9-pr, nb11=nb10-pr, nb12=nb11-pr

The information imported consists of the loan number, outstanding principal balance, current interest rate, and principal and interest monthly payment. The formula for calculating the monthly interest next expected is then inserted, the servicing fee rate, if applicable, is input and the servicing fee amount is then calculated, if applicable, net interest expected (gross interest less servicing fee), gross principal next expected and new principal balance after deducting the gross principal from the previous outstanding principal balance. The month applicable to all loans is shown in the heading.

This process is repeated on every loan until all loans listed vertically have been extended horizontally to show each payment expected until maturity on every loan. The spreadsheet contains twelve months of expected payments. A new spreadsheet is started each time twelve months of expected payments are recorded to provide a logical one year break in the recording process.

Then each vertical column is totaled to indicate the amount expected to be received on the entire portfolio 42 each month and the totals are recorded at the bottom of each spreadsheet. The totals are then recorded on the Loan Amortizing Program Summary Module 62. The totals are reconciled by adding the principal amounts to assure that the total principal equals the total amount of the portfolio 42 of loans collateralizing the issued investment certificates of the invention.

The Amortizing Program Summary Module 62 is then used to determine the amounts of the investment certificates of the invention which can be sold each month from the issue date of the program until the maturity of the program. The Summary is exported to the Investment Certificate Stratification Module 70 of FIG. 1, Certificate Stratification Program Issue Module 71 of FIG. 2, both exemplified in Table 3 to set up the initial amounts of the investment certificates of the invention.

### Stratify Certificates Investment Certificate Stratification Module

The next step in a preferred system of the invention is outlined in FIG. 1 generally indicated by the numeral 70 of FIG. 1 as the “Stratify Certificates in the Investment Certificate Stratification Module”, Certificate Stratification Program Issue Module 71 of FIG. 2, both exemplified in Table 3. Data is exported from the Loan Amortizing Program Module Summary 62 into the Investment Certificate Stratification Module 70 of FIG. 1, Certificate Stratification Program Issue Module 71 of FIG. 2, both exemplified in Table 3. This data includes, but is not limited to, the Total Principal Received, which is the principal generated by the underlying loans and the Total Interest Received, which is the interest, generated by the underlying loans in the portfolio 42 of loans collateralizing the issued investment certificates of the invention.

The Principal Received is imported from the Loan Amortizing Program Module Summary 62, separated by the month in which it will be received. It is then duplicated and the duplicate is named Total Certificate Principal. This is the amount at 100% which would be available to issue investment certificates each month. The Total Interest Received is imported from the Loan Amortizing Program Module Summary 62, separated by the month in which it will be received. It represents the maximum amount available to cover interest payments to investment certificate holders.

A certificate number is assigned and recorded in Investment Certificate Stratification Module 70 of FIG. 1, Certificate Stratification Program Issue Module 71 of FIG. 2, both exemplified in Table 3 and recorded in Certificate Owner Register Module 80 of FIG. 1 and in Investment Certificate Check Register 90 of FIG. 1. A certificate date is entered which is one month after the initial issue date. The Total Certificate Principal amount is then rounded to the nearest $1000 and the total certificate amount available for sale is entered. The excess principal amount is recorded below and represents the portion owned by the Issuer of the investment certificates of the invention.

The Investment Certificate Rate is then set, based upon current market data, and recorded at this time. Rates vary according to the amount of time the investment certificates will be outstanding. The Monthly Principal amount to be paid for each certificate maturity is recorded. The Monthly Interest amount to be paid for each month is recorded. The Maturity Date, beginning with the date one month after the Issue Date is recorded on the first certificate and one month is added to that date for each subsequent certificate until the final loan has matured.

This formula for Year 1 and each following year includes:

From Left to right, the input includes Total Principal Received=(tpr), Total Certificate Principal=(tep), Total Interest Received=(tir), Certificate Number, Certificate Date, Certificate Amount=(ca), Monthly Rate Paid=(rp), Monthly Principal Paid=(mpp), Monthly Interest Paid=(mip) and Certificate Maturity Date. All input data is a given value=(gv) (Value given/submitted by third party or data source); imported (im) or assigned (sg).

tcp=im

tir=im

Certificate Number=sg

Certificate Date=sg

ca=sg

rp=sg

mpp=sg

mip=(ca*rp)/12

Each Row is totaled at the bottom of that specific year and, at the bottom of the last year, all yearly totals are combined.

The Investment Certificate Stratification Module 70 of FIG. 1, Certificate Stratification Program Issue Module 71 of FIG. 2, both exemplified in Table 3 is created by using the Loan Amortizing Program Summary Module 62. The principal expected for each month is input vertically and, at this time, the amount available for a certificate is determined, rounding the amount to the nearest $1000 increment, such that the expected principal amount of $526,611.16 would support a certificate of $526,000.00. Each certificate amount for each subsequent month is determined in the same manner until all certificates have been issued through the last month in which the final loan matures.

In this embodiment of the invention, at least one certificate created thereby will mature on a monthly basis and the owner of the maturing certificate will receive interest specified in the certificate and the full face amount of the certificate. The owners of the remaining investment certificate will receive monthly interest only payments until their certificate matures, at which time they will receive the face amount of the certificate and the final monthly interest payment.

The first certificate will mature on the first day of the month following the initial sale of the first investment certificates of the invention and one certificate will mature each month thereafter. The amount of each initial certificate is the full amount of principal expected for that month, rounded down to the nearest $1000.

The certificates of the invention are then available for separation into smaller increments and may be split or divided to facilitate the market strategies and needs of those desiring to purchase investment certificates of the invention.

In the embodiment depicted, after the certificate amounts are determined for each monthly maturity, the rate of each certificate is determined. The rate determination is made based upon the current bond yield of both government bonds and corporate bonds, together with the FNMA 10 year A/A, the FNMA 15 year A/A, the FNMA 20 year A/A and the FNMA 30 year A/A yields. This data provides short term information on current market yields and intermediate and long term yields on mortgage loans.

Using these bond yields and mortgage yields as a guideline, the rate of each investment certificate is determined and recorded on the Investment Certificate Stratification Module 70, Certificate Stratification Program Issue Module 71, both exemplified in Table 3. Then the initial Investment Certificate Stratification Module 70, Certificate Stratification Program Issue Module 71 both exemplified in Table 3 is expanded on a monthly basis to quantify the amount of interest which will be paid monthly to the certificate owners and the amount of principal which will be paid monthly on the maturing certificate or certificates as shown in Table 3. The Stratification extends through the last month that includes the final maturing certificate.

The Investment Certificate Stratification Module 70 of FIG. 1, Certificate Stratification Program Issue Module 71 of FIG. 2, both shown in Table 3 then contains the amount of principal expected each month, the amount of principal available for a certificate, the amount of net interest expected each month, the Certificate Identification Number, the Certificate Date, the actual issued Certificate Amount, the Certificate Rate, the amount of the Maturing Certificate to be paid that particular month, the amount of interest to be paid on every certificate that particular month and the maturity date of every certificate, in a horizontal listing. Above each of these columns is the date of the month which applies to this particular listing.

The information is then repeated horizontally for eleven more months to include the actual issued certificate Amount, the certificate Rate, the amount of the Maturing certificate to be paid that particular month, the amount of interest to be paid on every certificate that particular month and the maturity date of every certificate.

As a twelve month spreadsheet is completed, a new spreadsheet is created on the next page, exactly like the first spreadsheet with the first twelve months of certificate information removed and the next twelve months determined. This process is repeated for all remaining twelve month periods until all of the certificates, issued in accordance with the invention, mature and the certificates have been fully funded.

A Certificate Stratification Program Issue Module Summary 72 of FIG. 2 exemplified in Table 3 is then prepared using the total principal and total interest data for each month from the first issue date until the final payment date. This summary will be used to manage the portfolio 42 of loans collateralizing the issued certificates by comparing the principal and interest funds received in the Cash Management Analysis of FIG. 3, and the principal and interest data received in the Data Management Analysis of FIG. 4.

The Certificate Stratification Program Issue Module Summary 72 exemplified in Table 3 summarizes the amounts to be paid to Certificate Holders during the full term of the Issue and is compared with the aggregate available principal of all loans comprising the Issue to assure adequate finds are forthcoming from the issue date to the final maturity to satisfy the full interest and principal amounts guaranteed in the Issue. The Stratification is also compared to the Loan Mapping Program Summary Module 54 exemplified in Table 1 to further verify that the portfolio 42 of loans will adequately and fully yield sufficient funds to guarantee full payment throughout the term of the certificates of the invention.

The certificates of the invention are then made available and issued for sale with a unique identification number for each investment certificate of the invention. As each investment certificate issued is sold, the Investment Certificate Owner is recorded on an Investment Certificate Owner Register 80.

### Record Investment Certificate Ownership in Investment Certificate Owner Register

The next step in a preferred system of the invention as outlined in FIG. 1 generally indicated by the numeral 80 is to “Record Investment Certificate Ownership in Investment Certificate Owner Register.”

In this particular embodiment, the Certificate Owner may receive a monthly interest check unless an Electronic Funds Transfer is desired. Checks will be issued or funds transferred through the EFT/ACH on a predetermined day of each month. If a check is desired, the Owner information and certificate information is recorded on a Check Register. If an EFT/ACH monthly funds transmittal is desired, the Bank Account information is recorded and the proper EFT/ACH information is recorded and initiated with the concentration bank (i.e., the bank through which EFT/ACH transactions are initiated).

In the embodiment depicted, when an outstanding Certificate is sold, the Certificate Owner Register 80 is amended to show the sale date of the outstanding investment certificate and a new Certificate Number is assigned to a new investment certificate. The Certificate Check Register 90 or the EFT/ACH batch is adjusted to remove the investment certificate of the invention which has been sold and add the new investment certificate of the invention.

When an investment certificate of the invention is split the outstanding Certificate is retired, on the Certificate Owner Register 80 and two or more new, unique Certificate Numbers are issued and recorded on the Investment Certificate Owner Register 80. The Investment Certificate Check Register 90 or the EFT/ACH batch is adjusted to remove the retired investment certificate of the invention and add the two or more new investment certificates of the invention.

When an investment certificate matures it is retired on the Certificate Owner Register 80 and is removed from Investment Certificate Check Register 90 or EFT/ACH batch.

### Record Investment Certificate Ownership in Investment Certificate Check Register

The next step in the preferred system of the invention as outlined in FIG. 1 generally indicated by the numeral 90 is “Record Investment Certificate Ownership in Investment Certificate Check Register.”

The Certificate Check Register 90 imports data from the Investment Certificate Stratification Module 70 of FIG. 1, Certificate Stratification Program Issue Module 71 of FIG. 2, both exemplified in Table 3 to record the Number, Maturity, Amount, Rate and Monthly Payment of. It utilizes simple addition to total the amounts of all of the certificates at the end of the Certificate Check Register 90.

The Certificate Check Register 90 contains the Certificate Number, the Federal Tax Identification Number of the Owner, the Owner Name, the Owner Mailing Address, the Certificate Maturity Date, and the Certificate Amount.

As each Certificate issued is sold, the Certificate Owner is recorded on the Certificate Check Register 90.

The certificate owner will receive a monthly interest check unless an Electronic Funds Transfer is desired. Checks will be issued or funds transferred through the EFT/ACH on the second working day of each month. If a check is desired, the Owner information and certificate information is recorded on the Certificate Check Register 90. If an EFT/ACH monthly finds transmittal is desired, the Bank Account information is recorded and the proper EFT/ACH information is recorded and initiated with the concentration bank.

The total of the EFT/ACH batch is added to the total of the monthly Check Register Batch to balance outgoing funds with the Investment Certificate Stratification Module 70 of FIG. 1, Certificate Stratification Program Issue Module 71 of FIG. 2 exemplified in Table 3 each month prior to issuing of checks and EFT/ACH Transmittal of funds.

When an outstanding Certificate is sold, the Certificate Owner Register 80 is amended to show the sale date of the outstanding Certificate and a new Certificate Number is assigned to a new Certificate. The Certificate Check Register 90 or the EFT/ACH Batch is adjusted to remove the Certificate which has been sold and add the new Certificate.

When a certificate is split the outstanding certificate is retired on the Certificate Owner Register 80 and two or more new, unique certificate numbers are issued and recorded on the Certificate Owner Register 80. The Certificate Check Register 90 or the EFT/ACH batch is adjusted to remove the retired certificate and add the two or more new Certificates.

When a certificate matures, it is retired on the Certificate Owner Register 80 and it is removed from the Certificate Check Register 90 or EFT/ACH batch.

### Manage Loan Portfolio Through Loan Portfolio Management Module

The next step in the preferred system of the invention outlined in FIG. 1 generally indicated by the numeral 100 is to “Manage Loan Portfolio Through Loan Portfolio Management Module”.

Management of the portfolio 42 utilizes the payment information generated by the underlying loans in various formats to analyze the portfolio 42 at the end of each month. Various reports gather specific information generated by the underlying loans, listing the data and employing simple addition to total the amounts at the end of each report or simple addition and/or subtraction to perform the appropriate reconciliation. Examples of such reports include:

| | |
|---|---|
| Trial Balance | Settlement of Cash Receipts |
| Collections | Paid In Full Loans |
| Advance | Foreclosures/loans Removed |
| Arrears | ARM Rate Changes |
| Curtailments | Service Fee Reconciliation |
| Loans Matured | Principal Balance Reconciliation |

Reports which utilize the exact formulas found in the Loan Amortizing Program Module 50, 61 and Table 2 include:

### Loan Substitution Investment Enhancement

A Receipts, Principal and Forecast Analysis Report may be prepared by importing information from the underlying loans, utilizing such aggregate reports as the Settlement of Cash Receipts indicated by blocks 101, 111 of FIG. 3 and blocks 121, 131 of FIG. 4. Based upon the Loan Amortizing Program Module 60, the Amortizing Program Issue Module 61 both exemplified in Table 2, the analysis incorporates the projected principal and interest amounts indicated by blocks 102, 112 of FIG. 3 and blocks 122, 132 of FIG. 4. The analysis then imports the actual principal and interest collections and any curtailment collections, payoffs, loan substitutions indicated by block 104 of FIG. 3, block 124 of FIG. 4 and investment enhancements. The analysis then imports principal and interest on loans paid in advance and delinquent loans which have not paid.

When all of the imported data is incorporated into the analysis, the analysis should be in perfect balance indicated by blocks 103, 113 of FIG. 3, and blocks 123, 133 of FIG. 4, such that interest expected, less interest received, plus interest in advance, less delinquent interest, less interest expected on payoffs unpaid or interest expected on payoffs which was exceeded will equal zero. Loan substitutions and/or investment enhancements will also affect this balancing procedure and must be added or subtracted, depending on when the loans were added to the portfolio 42. Principal would be balanced in the identical manner.

The forecasted interest may be calculated, as an additional reconciliation tool, by multiplying the adjusted outstanding principal balance by the weighted average interest rate divided by twelve. This amount should be matched to the forecasted interest derived from the adjusted Loan Amortizing Program Module 60, Amortizing Program Issue Module 61 and Table 2 interest forecast.

The forecasted principal amount would be the difference between the calculated forecasted interest amount and the constant payment (principal and interest amount).

Calculation of the forecasted interest and forecasted principal further substantiate the interest and principal amounts derived at by the Loan Amortizing Program Module 60, Amortizing Program Issue Module 61 and Table 2, as adjusted, and provide Management with additional data to support its ongoing portfolio 42 management.

Management of the portfolio 42 of loans collateralizing the issued Certificates of the invention is a multi-step, on-going process. It assures the holders of the Certificates of the invention of timely current and future payments and it assures sufficient collateral to generate the required funds for both future interest payments and future principal payments in the amounts and at the rates originally guaranteed in the Certificates of the invention.

There preferably is a continuous cash management analysis and a continuous data management analysis, outlined in FIGS. 3 and 4 respectively, undertaken to identify payments of unexpected principal where it is necessary to substitute a loan or loans, in whole or in part, to maintain the integrity of the portfolio 42 of loans collateralizing the issued certificates. When it becomes necessary to substitute a loan or loans, in whole or in part, and loans are not readily available for purchase in the marketplace and the General Loan Portfolio has been depleted, a mortgage-backed investment may be substituted in whole or in part and provide the same advantages as a loan substitution.

The substitution of a loan or loans, in whole or in part, entails purchasing a loan, usually from the General/Auxiliary portfolio preferably maintained by the issuer, with the excess cash generated by a loan paid in full, a curtailment of principal or a loan removed for foreclosure, modification or bankruptcy.

The issuer may, from time to time, elect to enhance its Investment by substituting loans which exceed the amount required to replace loans which have paid in full or loans which have been removed for foreclosure, excessive delinquency during bankruptcy or modification. If the issuer elects to enhance its investment, the issuer further assures that the issue will generate adequate principal and interest over the expected life of the issue.

The issuer of the certificates of the invention manages the portfolio 42 of loans collateralizing the issued certificates by monitoring the available loan data, e.g., by using a multitude of comprehensive reports which are designed to identify variances in receipt of cash and variances in receipt of loan data to pinpoint the need for substitution of a loan or loans, in whole or in part, to supplement unexpected receipts of principal as a result of curtailments and payoffs or loan removals caused by foreclosures, loan modifications or excessive delinquencies of loans in bankruptcy.

The cash/data management reconciliation is a conventional tool used to provide a comprehensive process which uses a variety of forms and reports to analyze, review, compare and control both the cash and the data generated by the underlying loans. The cash/data management reconciliation collects its data from the activity and inactivity generated by the underlying loans which belong to the portfolio 42 of loans collateralizing the issued investment certificates of the invention.

Reports are prepared using the loan activity or inactivity and the totals from these reports are exported to the Receipts, Principal & Forecast Analysis.

A Principal Balance Reconciliation Report should be produced every month, for it is an integral part of the reconciliation process. It aligns the present balance with the forecasted balance and defines the exact areas where differences and deviations have occurred. This report measures the changes in the overall balance and points out the causes for those changes which then allows for loan substitution, as needed. The actual portfolio 42 of loans collateralizing the issued certificates balance is compared with the Amortizing Program Issue Base Module 60, Amortizing Program Issue Module 61 exemplified by Table 2 and differences are measured and defined. If the differences have occurred because of loans paid in advance and loans in arrears, no real difference exists other than one of timing of receipt of funds. This is also true of curtailments where the total funds received are insignificant. When loans have been removed and funds received to cover those removals, this report provides a concise amount of principal which must be replaced with a loan or loans, in whole or in part, to make up unexpected receipt of principal and assure the integrity of the portfolio 42 of loans collateralizing the issued investment certificates of the invention.

When the issuer has elected to enhance its investment in the portfolio 42 of loans collateralizing the issued investment certificates of the invention, it may substitute a loan or loans, in whole or in part, which exceed the amount necessary to replenish the loans removed through payoff, foreclosure, modification or bankruptcy. The issuer may elect, from time to time, to enhance its investment (ownership interest) in the program issue when there have been no loans removed in a given month, and the issuer should prepare an Investment Enhancement Report Table listing the exact information, on a loan by loan basis, that is included in the Amortizing Program Issue Module 61.

The Receipts, Principal & Forecast Analysis Tables will show a reduction in the beginning principal balance by the principal received for a given month from all sources. Curtailments and payoffs will cause a principal reduction, as well as loans removed for foreclosure, modification or bankruptcy. Substitutions will cause a principal increase. The remaining balance is then calculated and should correspond to the outstanding principal balance on the end of month trial balance. Of course, the loan count is reduced by payoffs and removals while it is increased by substitutions. In addition, the constant payment (principal and interest monthly payment) is reduced by payoffs and loan removals and increased by substitutions.

The Receipts, Principal & Forecast Analysis Tables finally calculate the amount of principal and interest expected for the coming month by using the outstanding balance on each loan multiplied by its rate and divided by twelve to find the next expected interest payment as though all loans were current. It then deducts the interest amount from the total constant payment to determine the amount of principal which will be paid as though all loans were current Finally it adjusts the calculations by adding delinquent payments and deducting prepaid payments to determine the amount expected to be received in the coming month. If there are maturing loans, it deducts the principal difference on the Maturing Loan Report Tables. The ending forecasted balances for the current month become the beginning forecasted balances for the coming month. The ending loan count, constant payment and outstanding principal balance for the current month become the beginning forecasted balances for the coming month. This monthly process continues until all loans have matured and all certificates have matured and the portfolio 42 of loans collateralizing the issued certificates has been fully funded and closed.

At this point in the current month, it is necessary to verify that loans have been substituted during the month as payoffs were received. If substitutions were not made to coincide with receipt of payoff funds, loan removals or substantial curtailments, it is necessary to make loan substitutions as soon as feasible to assure the continued integrity of the portfolio 42 of loans collateralizing the issued Certificates.

An Issuer Management review of all monthly reports is completed to further assure that the integrity of the portfolio 42 of loans collateralizing the issued investment certificates of the invention is fully and completely maintained.

All reports from the current month are stored on internal and external data storage mediums and labeled with the month the records represent and the portfolio 42 of loans collateralizing the issued investment certificates of the invention which the reports represent. The Issuer has the ability to reproduce all reports when the need arises.

In the practice of the present invention, it should be appreciated that substitution of a higher rate, newly generated loan for an existing loan within a portfolio of loans serving as collateral usually creates a very desirable situation. It requires comparison of the loan removed with the new loan substituted to assure that sufficient principal and interest is generated to service the certificate principal and interest debt.

If there have been previous substitutions of higher rate loans for lower rate loans which have been removed in the past, a small number of loan removals may not materially affect the amount of monthly principal received in a given month. Sufficient principal may still be generated to service the maturing debt.

When loans with lower rates are substituted for higher rate loans, a principal timing difference occurs in the first month following substitution and the resulting principal may be insufficient to support the guaranteed principal of the certificate maturing, depending upon the significance of the difference in interest rates.

If a large number of loans are replaced through substitution, and the substitution appears to be driven by a sizeable market rate reduction which causes, e.g., a spike in payoffs, it may be necessary to replace those loans with substitute loans which are at lower market rates. This may create a large principal shortfall which should be immediately addressed. In one embodiment of this invention, the principal shortfall realized in this situation may be borrowed from a new issue during the first months of the shortfall and repaid to the new issue from which it was borrowed in later months. Lending principal to a previous issue and recovering the loaned principal in later months will usually result in continued profits for both issues, without considering any reinvestment potential of excess funds.

In using a Substitution Control Module or analysis, the first step is to define the loans which have paid in full. Each loan group is amortized, using the same criteria, formulas, data and information found on the Amortizing Program Module. Payoffs will affect the amortization of payments, beginning with the payoff date and ending when the payoffs mature to zero.

Once loans have been chosen to substitute, the substituted loans must be amortized. The differences in amortization between the loans removed and the loans substituted must then be analyzed to determine the effect the substitution is having on the amount of available principal. The amount of available principal drops through substitution to a level which jeopardizes the issuer's ability to meet its ongoing certificate obligations, the amount of the short fall should be determined and borrowed.

The final step is to borrow from a subsequent issue that sum which is needed to provide sufficient principal to the previous issue to service the maturing debt to the certificate holders. At some point the principal shortfall will reverse itself, the point in time depending upon the rates of the loans which are substituted, and the issue will begin generating excess principal which will then be returned to the issue from which it was borrowed initially.

The new issue will sell certificates in a face amount which is less than it would otherwise support in the early years and in a face amount which is more than it would otherwise support in later years. This situation is a direct result of having loaned some of its principal to a previous issue and then recovering that principal when the previous issue begins to produce excess principal. In this way, the rare event of a significant rate reduction setting up a potential shortfall in the issuer's ability to make payment obligations can be covered through taking advantage of the available funds in a new issue.

It should be appreciated that the true scope of this invention is broader than, and should not be limited to, the particular illustrative embodiments described herein. Rather, the scope of this invention is defined by the following claims, construed in accordance with applicable law.

TABLE 1
LOAN MAPPING PROGRAM
Remaining Term Ascending Order with Term Summary

| | | Annual | Monthly | | |
|---|---|---|---|---|---|
| Loan | Outstanding | Interest | Principal and | Annual | Term In |
| Number | Balance | Rate | Interest | Interest | Months |
| 480 | $0.00 | 8.500% | $295.42 | $0.00 | 0.00 |
| 1786 | $78.01 | 9.750% | $340.00 | $7.61 | 1.00 |
| 1746 | $264.01 | 8.950% | $518.35 | $23.63 | 1.00 |
| * * * | * * * | * * * | * * * | * * * | * * * |
| 1627 | $24,300.00 | 8.500% | $239.29 | $2,065.50 | 180.0 |
| 1650 | $50,000.00 | 7.000% | $449.41 | $3,500.00 | 180.0 |
| 1631 | $25,000.00 | 7.500% | $231.75 | $1,875.00 | 180.0 |
| TOTAL | $52,939,637.57 | | $870,076.98 | $4,101,218.21 | |

Term Summary

| | Weighted | Aggregate | Aggregate | Term In |
|---|---|---|---|---|
| Outstanding | Average Annual | Monthly Principal | Annual | Months |
| Balance | Interest Rate | and Interest | Interest | Summary |
| $59,317.90 | 8.800% | $22,484.54 | $5,221.23 | 1-5 |
| $606,060.88 | 7.980% | $59,438.07 | $48,358.90 | 6-17 |
| $801,401.13 | 7.440% | $37,492.08 | $59,663.40 | 18-29 |
| $1,358,326.73 | 8.110% | $44,877.62 | $110,219.51 | 30-41 |
| $5,450,404.12 | 7.140% | $133,146.03 | $389,259.31 | 42-53 |
| $2,976,702.77 | 7.610% | $62,137.13 | $226,641.58 | 54-65 |
| $2,800,545.85 | 8.270% | $49,895.97 | $231,547.78 | 66-77 |
| $3,759,898.63 | 7.740% | $58,083.04 | $291,056.38 | 78-89 |
| $3,033,184.58 | 8.330% | $44,020.48 | $252,541.94 | 90-101 |
| $9,239,543.31 | 7.420% | $118,653.82 | $685,386.65 | 102-113 |
| $4,444,637.13 | 7.330% | $53,708.70 | $325,641.24 | 114-125 |
| $1,055,368.44 | 8.710% | $12,491.04 | $91,953.37 | 126-137 |
| $1,607,076.05 | 8.460% | $17,803.73 | $135,948.06 | 138-149 |
| $2,667,131.92 | 8.910% | $29,106.85 | $237,653.01 | 150-161 |
| $8,098,792.06 | 7.840% | $79,906.18 | $635,226.93 | 162-173 |
| $4,981,246.07 | 7.530% | $46,831.70 | $374,898.93 | 174-180 |
| $52,939,637.57 | 7.75% | $870,076.98 | $4,101,218.22 | |

TABLE 2
Amortizing Program Module
YEAR 1

TOP YEAR 1

| A | B | C | D | E | F | G | H | I | J | K | L |
|---|---|---|---|---|---|---|---|---|---|---|---|
| | Oct. 1, 2002 | | | | | | | | Nov. 1, 2002 | | |
| | | | | | | SER- | | | | | SER- |
| | | | | | SER- | VICE | NET | | | | VICE |
| LOAN | | | | IN- | VICE | FEE | IN- | PRIN- | NEW | IN- | FEE |
| NUM- | BAL- | | | TER- | FEE | PAY- | TER- | CI- | BAL- | TER- | PAY- |
| BER | ANCE | RATE | P&I | EST | RATE | ABLE | EST | PAL | ANCE | EST | ABLE |
| 1631 | $25,000.00 | 7.500% | $231.75 | $156.25 | 0.500% | $10.42 | $145.83 | $75.50 | $24,924.50 | $155.78 | $10.39 |
| 1650 | $50,000.00 | 7.000% | $449.41 | $291.67 | 0.500% | $20.83 | $270.83 | $157.74 | $49,842.26 | $290.75 | $20.77 |
| 1627 | $24,300.00 | 8.500% | $239.29 | $172.13 | 0.500% | $10.13 | $162.00 | $67.17 | $24,232.84 | $171.65 | $10.10 |

TOP YEAR 1

| ++M | N | O | P | Q | R | S | T | U | V | W | X |
|---|---|---|---|---|---|---|---|---|---|---|---|
| | | Dec. 1, 2002 | | | | | Jan. 1, 2003 | | | | |
| | | | | SER- | | | | | SER- | | |
| | | | | VICE | NET | | | | VICE | NET | |
| NET | PRIN- | NEW | | FEE | IN- | PRIN- | NEW | IN- | FEE | IN- | PRIN- |
| INTER- | CI- | BAL- | INTER- | PAY- | TER- | CI- | BAL- | TER- | PAY- | TER- | CI- |
| EST | PAL | ANCE | EST | ABLE | EST | PAL | ANCE | EST | ABLE | EST | PAL |
| $145.39 | $75.97 | $24,848.53 | $155.30 | $10.35 | $144.95 | $76.45 | $24,772.08 | $154.83 | $10.32 | $144.50 | $76.92 |
| $269.98 | $158.66 | $49,683.59 | $289.82 | $20.70 | $269.12 | $159.59 | $49,524.00 | $288.89 | $20.64 | $268.26 | $160.52 |
| $161.55 | $67.64 | $24,165.19 | $171.17 | $10.07 | $161.10 | $68.12 | $24,097.07 | $170.69 | $10.04 | $160.65 | $68.60 |

TOP YEAR 1

| ++Y | Z | AA | AB | AC | AD | AE | AF | AG | AH | AI | AJ |
|---|---|---|---|---|---|---|---|---|---|---|---|
| Feb. 1, 2003 | | | | | Mar. 1, 2003 | | | | | Apr. 1, 2003 | |
| | | SER- | | | | | SER- | | | | |
| | | VICE | NET | | | | VICE | NET | | | |
| NEW | IN- | FEE | IN- | PRIN- | NEW | IN- | FEE | IN- | PRIN- | NEW | IN- |
| BAL- | TER- | PAY- | TER- | CI- | BAL- | TER- | PAY- | TER- | CI- | BAL- | TER- |
| ANCE | EST | ABLE | EST | PAL | ANCE | EST | ABLE | EST | PAL | ANCE | EST |
| $24,695.16 | $154.34 | $10.29 | $144.06 | $77.41 | $24,617.75 | $153.86 | $10.26 | $143.60 | $77.89 | $24,539.86 | $153.37 |
| $49,363.48 | $287.95 | $20.57 | $267.39 | $161.46 | $49,202.03 | $287.01 | $20.50 | $266.51 | $162.40 | $49,039.63 | $286.06 |
| $24,028.47 | $170.20 | $10.01 | $160.19 | $69.09 | $23,959.38 | $169.71 | $9.98 | $159.73 | $69.58 | $23,889.81 | $169.22 |

TOP YEAR 1

| ++AK | AL | AM | AN | AO | AP | AQ | AR | AS | AT | AU | AV |
|---|---|---|---|---|---|---|---|---|---|---|---|
| | | | May 1, 2003 | | | | | Jun. 1, 2003 | | | |
| SER- | | | | | SER- | | | | | SER- | |
| VICE | NET | | | | VICE | NET | | | | VICE | NET |
| FEE | IN- | PRIN- | NEW | IN- | FEE | IN- | PRIN- | NEW | IN- | FEE | IN- |
| PAY- | TER- | CI- | BAL- | TER- | PAY- | TER- | CI- | BAL- | TER- | PAY- | TER- |
| ABLE | EST | PAL | ANCE | EST | ABLE | EST | PAL | ANCE | EST | ABLE | EST |
| $10.22 | $143.15 | $78.38 | $24,461.49 | $152.88 | $10.19 | $142.69 | $78.87 | $24,382.62 | $152.39 | $10.16 | $142.23 |
| $20.43 | $265.63 | $163.35 | $48,876.28 | $285.11 | $20.37 | $264.75 | $164.30 | $48,711.99 | $284.15 | $20.30 | $263.86 |
| $9.95 | $159.27 | $70.07 | $23,819.74 | $168.72 | $9.92 | $158.80 | $70.57 | $23,749.17 | $168.22 | $9.90 | $158.33 |

TOP YEAR 1

| ++AW | AX | AY | AZ | BA | BB | BC | BD | BE | BF | BG | BH |
|---|---|---|---|---|---|---|---|---|---|---|---|
| | Jul. 1, 2003 | | | | | Aug. 1, 2003 | | | | | Sep. 1, 2003 |
| | | | SER- | | | | | SER- | | | |
| | | | VICE | NET | | | | VICE | NET | | |
| PRIN- | NEW | IN- | FEE | IN- | PRIN- | NEW | IN- | FEE | IN- | PRIN- | NEW |
| CI- | BAL- | TER- | PAY- | TER- | CI- | BAL- | TER- | PAY- | TER- | CI- | BAL- |
| PAL | ANCE | EST | ABLE | EST | PAL | ANCE | EST | ABLE | EST | PAL | ANCE |
| $79.36 | $24,303.26 | $151.90 | $10.13 | $141.77 | $79.85 | $24,223.41 | $151.40 | $10.09 | $141.30 | $80.35 | $24,143.05 |
| $165.26 | $48,546.73 | $283.19 | $20.23 | $262.96 | $166.22 | $48,380.51 | $282.22 | $20.16 | $262.06 | $167.19 | $48,213.32 |
| $71.07 | $23,678.10 | $167.72 | $9.87 | $157.85 | $71.57 | $23,606.53 | $167.21 | $9.84 | $157.38 | $72.08 | $23,534.45 |

TOP YEAR 1

| ++BI | BJ | BK | BL | BM |
|---|---|---|---|---|
| | | | | Oct. 1, 2003 |
| | SER- | | | |
| | VICE | NET | | |
| IN- | FEE | IN- | PRIN- | NEW |
| TER- | PAY- | TER- | CI- | BAL- |
| EST | ABLE | EST | PAL | ANCE |
| $150.89 | $10.06 | $140.83 | $80.86 | $24,062.20 |
| $281.24 | $20.09 | $261.16 | $168.17 | $48,045.15 |
| $166.70 | $9.81 | $156.90 | $72.59 | $23,461.87 |

BOTTOM YEAR 1

| *A | *B | *C | *D | *E | *F | *G | *H | *I | *J | *K | *L |
|---|---|---|---|---|---|---|---|---|---|---|---|
| | Oct. 1, 2002 | | | | | | | | Nov. 1, 2002 | | |
| | | | | | | SER- | | | | | SER- |
| | | | | | SER- | VICE | NET | | | | VICE |
| LOAN | | | | IN- | VICE | FEE | IN- | PRIN- | NEW | IN- | FEE |
| NUM- | BAL- | | | TER- | FEE | PAY- | TER- | CI- | BAL- | TER- | PAY- |
| BER | ANCE | RATE | P&I | EST | RATE | ABLE | EST | PAL | ANCE | EST | ABLE |
| 1746 | $264.01 | 8.950% | $518.35 | $1.97 | 0.500% | $0.11 | $1.86 | $264.01 | $0.00 | $0.00 | $0.00 |
| 1786 | $78.01 | 8.750% | $340.00 | $0.63 | 0.500% | $0.03 | $0.60 | $78.01 | $0.00 | $0.00 | $0.00 |
| 480 | $0.00 | 8.500% | $295.42 | $0.00 | 0.500% | $0.00 | $0.00 | $0.00 | $0.00 | $0.00 | $0.00 |
| TOTAL: | $52,939,637.57 | | $870,076.98 | $341,768.18 | | $22.058.18 | $319,710.00 | $526,611.16 | $52,413,026.41 | $338,383.96 | $21,838.76 |

BOTTOM YEAR 1

| *M | *N | *O | *P | *Q | *R | *S | *T | *U | *V | *W | *X |
|---|---|---|---|---|---|---|---|---|---|---|---|
| | | Dec. 1, 2002 | | | | | Jan. 1, 2003 | | | | |
| | | | | SER- | | | | | SER- | | |
| NET | | | | VICE | NET | | | | VICE | NET | |
| IN- | PRIN- | NEW | IN- | FEE | IN- | PRIN- | NEW | IN- | FEE | IN- | PRIN- |
| TER- | CI- | BAL- | TER- | PAY- | TER- | CI- | BAL- | TER- | PAY- | TER- | CI- |
| EST | PAL | ANCE | EST | ABLE | EST | PAL | ANCE | EST | ABLE | EST | PAL |
| $0.00 | $0.00 | $0.00 | $0.00 | $0.00 | $0.00 | $0.00 | $0.00 | $0.00 | $0.00 | $0.00 | $0.00 |
| $0.00 | $0.00 | $0.00 | $0.00 | $0.00 | $0.00 | $0.00 | $0.00 | $0.00 | $0.00 | $0.00 | $0.00 |
| $0.00 | $0.00 | $0.00 | $0.00 | $0.00 | $0.00 | $0.00 | $0.00 | $0.00 | $0.00 | $0.00 | $0.00 |
| $316,545.20 | $526,399.98 | $51,886,626.43 | $335,004.73 | $21,619.43 | $313,385.30 | $525,740.47 | $51,360,885.96 | $331,633.32 | $21,400.37 | $310,232.95 | $522,699.56 |

BOTTOM YEAR 1

| *Y | *Z | *AA | *AB | *AC | *AD | *AE | *AF | *AG | *AH | *AI | *AJ |
|---|---|---|---|---|---|---|---|---|---|---|---|
| Feb. 1, 2003 | | | | | Mar. 1, 2003 | | | | | Apr. 1, 2003 | |
| | | SER- | | | | | SER- | | | | |
| | | VICE | NET | | | | VICE | NET | | | |
| NEW | IN- | FEE | IN- | PRIN- | NEW | IN- | FEE | IN- | PRIN- | NEW | IN- |
| BAL- | TER- | PAY- | TER- | CI- | BAL- | TER- | PAY- | TER- | CI- | BAL- | TER- |
| ANCE | EST | ABLE | EST | PAL | ANCE | EST | ABLE | EST | PAL | ANCE | EST |
| $0.00 | $0.00 | $0.00 | $0.00 | $0.00 | $0.00 | $0.00 | $0.00 | $0.00 | $0.00 | $0.00 | $0.00 |
| $0.00 | $0.00 | $0.00 | $0.00 | $0.00 | $0.00 | $0.00 | $0.00 | $0.00 | $0.00 | $0.00 | $0.00 |
| $0.00 | $0.00 | $0.00 | $0.00 | $0.00 | $0.00 | $0.00 | $0.00 | $0.00 | $0.00 | $0.00 | $0.00 |
| $50,838,186.39 | $328,287.41 | $21,182.58 | $307,104.83 | $521,716.08 | $50,316,470.31 | $324,951.08 | $20,965.20 | $303,985.88 | $521,044.33 | $49,795,425.98 | $321,620.59 |

BOTTOM YEAR 1

| *AK | *AL | *AM | *AN | *AO | *AP | *AQ | *AR | *AS | *AT | *AU | *AV |
|---|---|---|---|---|---|---|---|---|---|---|---|
| | | | May 1, 2003 | | | | | Jun. 1, 2003 | | | |
| SER- | | | | | SER- | | | | | SER- | |
| VICE | NET | | | | VICE | NET | | | | VICE | NET |
| FEE | IN- | PRIN- | NEW | IN- | FEE | IN- | PRIN- | NEW | IN- | FEE | IN- |
| PAY- | TER- | CI- | BAL- | TER- | PAY- | TER- | CI- | BAL- | TER- | PAY- | TER- |
| ABLE | EST | PAL | ANCE | EST | ABLE | EST | PAL | ANCE | EST | ABLE | EST |
| $0.00 | $0.00 | $0.00 | $0.00 | $0.00 | $0.00 | $0.00 | $0.00 | $0.00 | $0.00 | $0.00 | $0.00 |
| $0.00 | $0.00 | $0.00 | $0.00 | $0.00 | $0.00 | $0.00 | $0.00 | $0.00 | $0.00 | $0.00 | $0.00 |
| $0.00 | $0.00 | $0.00 | $0.00 | $0.00 | $0.00 | $0.00 | $0.00 | $0.00 | $0.00 | $0.00 | $0.00 |
| $20,748.09 | $300,872.50 | $516,307.63 | $49,279,118.35 | $318,319.14 | $20,532.97 | $297,786.18 | $516,084.62 | $48,763,033.73 | $315,019.55 | $20,317.93 | $294,701.62 |

BOTTOM YEAR 1

| *AW | *AX | *AY | *AZ | *BA | *BB | *BC | *BD | *BE | *BF | *BG | *BH |
|---|---|---|---|---|---|---|---|---|---|---|---|
| | Jul. 1, 2003 | | | | | Aug. 1, 2003 | | | | | Sep. 1, 2003 |
| | | | SER- | | | | | SER- | | | |
| | | | VICE | NET | | | | VICE | NET | | |
| PRIN- | NEW | IN- | FEE | IN- | PRIN- | NEW | IN- | FEE | IN- | PRIN- | NEW |
| CI- | BAL- | TER- | PAY- | TER- | CI- | BAL- | TER- | PAY- | TER- | CI- | BAL- |
| PAL | ANCE | EST | ABLE | EST | PAL | ANCE | EST | ABLE | EST | PAL | ANCE |
| $0.00 | $0.00 | $0.00 | $0.00 | $0.00 | $0.00 | $0.00 | $0.00 | $0.00 | $0.00 | $0.00 | $0.00 |
| $0.00 | $0.00 | $0.00 | $0.00 | $0.00 | $0.00 | $0.00 | $0.00 | $0.00 | $0.00 | $0.00 | $0.00 |
| $0.00 | $0.00 | $0.00 | $0.00 | $0.00 | $0.00 | $0.00 | $0.00 | $0.00 | $0.00 | $0.00 | $0.00 |
| $514,762.05 | $48,248,271.68 | $311,730.00 | $20,103.45 | $291,626.55 | $511,894.41 | $47,736,377.27 | $308,461.79 | $19,890.16 | $288,571.63 | $510,443.35 | $47,225,933.92 |

BOTTOM YEAR 1

| *BI | *BJ | *BK | *BL | *BM |
|---|---|---|---|---|
| | | | | Oct. 1, 2003 |
| $0.00 | $0.00 | $0.00 | $0.00 | $0.00 |
| $0.00 | $0.00 | $0.00 | $0.00 | $0.00 |
| $0.00 | $0.00 | $0.00 | $0.00 | $0.00 |
| $305,203.30 | $19,677.47 | $285,525.83 | $507,057.72 | $46,718,876.21 |

Year 16

TOTAL YEAR 16

| A | B | C | D | E | F | G |
|---|---|---|---|---|---|---|
| | Oct. 1, 2017 | | | | | |
| LOAN | | | | | SERVICE FEE | SERVICE FEE |
| NUMBER | BALANCE | RATE | P&I | INTEREST | RATE | PAYABLE |
| 1631 | $1.02 | 7.500% | $231.75 | $0.01 | 0.500% | $0.00 |
| 1650 | $1.31 | 7.000% | $449.41 | $0.01 | 0.500% | $0.00 |
| 1627 | $0.62 | 8.500% | $239.29 | $0.00 | 0.500% | $0.00 |
| 1634 | $0.57 | 7.250% | $1,186.72 | $0.00 | 0.500% | $0.00 |
| TOTAL: | $3.52 | | $2,107.17 | $0.02 | | $0.00 |

TOTAL YEAR 16

| ++H | I | J | K | L | M |
|---|---|---|---|---|---|
| | | Nov. 1, 2017 | | | |
| | | | | SERVICE FEE | |
| NET INTEREST | PRINCIPAL | NEW BALANCE | INTEREST | PAYABLE | NET INTEREST |
| $0.01 | $1.02 | $0.00 | $0.00 | $0.00 | $0.00 |
| $0.01 | $1.31 | $0.00 | $0.00 | $0.00 | $0.00 |
| $0.00 | $0.62 | $0.00 | $0.00 | $0.00 | $0.00 |
| $0.00 | $0.57 | $0.00 | $0.00 | $0.00 | $0.00 |
| $0.02 | $3.52 | $0.00 | $0.00 | $0.00 | $0.00 |

Note:
++denotes continuation of the first three loans of the upper table's right most cells
*denotes last three loans' Columns (At the bottom) of the Amortizing Program Module

TABLE 3

| A | B | C | D | E | F | G | H | I | J |
|---|---|---|---|---|---|---|---|---|---|
| YEAR 1 | | | | | Oct. 1, 2002 | | | | |
| TOTAL | TOTAL | TOTAL | | | | | MONTH- | MONTH- | CERTIF- |
| PRIN- | CERTIF- | INT- | CERTIF- | CERTIF- | CERTIF- | | LY | LY | ICATE |
| CIPAL | ICATE | EREST | ICATE | ICATE | ICATE | MON. | PRIN- | INT- | MATU- |
| RE- | PRIN- | RE- | ID | ISSUE | AMOUNT | RATE | CIPAL | EREST | RITY |
| CEIVED | CIPAL | CEIVED | NUMBER | DATE | ISSUED | PAID | PAID | PAID | DATE |
| 526,611.16 | 526,611.16 | 319,710.00 | A0000001 | Nov. 1, 2002 | 526000.00 | 2.000% | 526000.00 | 876.67 | Nov. 1, 2002 |
| | | | | | 611.16 | 2.000% | 611.16 | 1.02 | Nov. 1, 2002 |
| 526,399.98 | 526,399.98 | 316,545.20 | A0000002 | Nov. 1, 2002 | 526000.00 | 2.000% | | 878.67 | Dec. 1, 2002 |
| | | | | | 399.98 | 2.000% | | 0.67 | Dec. 1, 2002 |
| 525,740.47 | 525,740.47 | 313,385.30 | A0000003 | Nov. 1, 2002 | 525000.00 | 2.000% | | 875.00 | Jan. 1, 2003 |
| | | | | | 740.47 | 2.000% | | 1.23 | Jan. 1, 2003 |
| 522,699.56 | 522,699.56 | 310,232.95 | A0000004 | Nov. 1, 2002 | 522000.00 | 2.000% | | 870.00 | Feb. 1, 2003 |
| | | | | | 699.56 | 2.000% | | 1.17 | Feb. 1, 2003 |
| 521,716.08 | 521,716.08 | 307,104.83 | A0000005 | Nov. 1, 2002 | 521000.00 | 2.000% | | 868.33 | Mar. 1, 2003 |
| | | | | | 716.08 | 2.000% | | 1.19 | Mar. 1, 2003 |
| 521,044.33 | 521,044.33 | 303,985.88 | A0000006 | Nov. 1, 2002 | 521000.00 | 2.000% | | 868.33 | Apr. 1, 2003 |
| | | | | | 44.33 | 2.000% | | 0.07 | Apr. 1, 2003 |
| 516,307.63 | 516,307.63 | 300,872.50 | A0000007 | Nov. 1, 2002 | 516000.00 | 2.000% | | 860.00 | May 1, 2003 |
| | | | | | 307.63 | 2.000% | | 0.51 | May 1, 2003 |
| 516,084.62 | 516,084.62 | 297,786.18 | A0000008 | Nov. 1, 2002 | 516000.00 | 2.000% | | 860.00 | Jun. 1, 2003 |
| | | | | | 84.62 | 2.000% | | 0.14 | Jun. 1, 2003 |
| 514,762.05 | 514,762.05 | 294,701.62 | A0000009 | Nov. 1, 2002 | 514000.00 | 2.000% | | 856.67 | Jul. 1, 2003 |
| | | | | | 762.05 | 2.000% | | 1.27 | Jul. 1, 2003 |
| 511,894.41 | 511,894.41 | 291,626.55 | A0000010 | Nov. 1, 2002 | 511000.00 | 2.000% | | 851.67 | Aug. 1, 2003 |
| | | | | | 894.41 | 2.000% | | 1.49 | Aug. 1, 2003 |
| 510,443.35 | 510,443.35 | 288,571.63 | A0000011 | Nov. 1, 2002 | 510000.00 | 2.000% | | 850.00 | Sep. 1, 2003 |
| | | | | | 443.35 | 2.000% | | 0.74 | Sep. 1, 2003 |
| 507,057.72 | 507,057.72 | 285,525.83 | A0000012 | Nov. 1, 2002 | 507000.00 | 2.000% | | 845.00 | Oct. 1, 2003 |
| | | | | | 57.72 | 2.000% | | 0.10 | Oct. 1, 2003 |
| 6,220,761.36 | 6,220,761.36 | 3,630,048.47 | | | 6,220,761.36 | | 526,611.16 | 10,367.94 | |

YEAR 1 OF 16 YEARS TOTAL ON SHEET 1

| ++K | L | M | N | O | P | Q | R | S | T | U | V | W | X |
|---|---|---|---|---|---|---|---|---|---|---|---|---|---|
| Nov. 1, 2002 | | | | | | Dec. 1, 2002 | | | | | | Jan. 1, 2003 | |
| | | MONTH- | MONTH- | CERTIF- | | | | MONTH- | MONTH- | CERTIF- | | | |
| CERTIF- | | LY | LY | ICATE | | CERTIF- | | LY | LY | ICATE | | CERTIF- | |
| ICATE | MON. | PRIN- | INT- | MATU- | | ICATE | MON. | PRIN- | INT- | MATU- | | ICATE | MON. |
| AMOUNT | RATE | CIPAL | EREST | RITY | | AMOUNT | RATE | CIPAL | EREST | RITY | | AMOUNT | RATE |
| ISSUED | PAID | PAID | PAID | DATE | | ISSUED | PAID | PAID | PAID | DATE | | ISSUED | PAID |
| 526000.00 | 2.000% | 526000.00 | 876.67 | Dec. 1, 2002 | | | | | | | | | |
| 399.98 | 2.000% | 399.98 | 0.67 | Dec. 1, 2002 | | | | | | | | | |
| 525000.00 | 2.000% | | 875.00 | Jan. 1, 2003 | | 525000.00 | 2.000% | 525000.00 | 875.00 | Jan. 1, 2003 | | | |
| 740.47 | 2.000% | | 1.23 | Jan. 1, 2003 | | 740.47 | 2.000% | 740.47 | 1.23 | Jan. 1, 2003 | | | |
| 522000.00 | 2.000% | | 870.00 | Feb. 1, 2003 | | 522000.00 | 2.000% | | 870.00 | Feb. 1, 2003 | | 522000.00 | 2.000% |
| 699.56 | 2.000% | | 1.17 | Feb. 1, 2003 | | 699.56 | 2.000% | | 1.17 | Feb. 1, 2003 | | 699.56 | 2.000% |
| 521000.00 | 2.000% | | 868.33 | Mar. 1, 2003 | | 521000.00 | 2.000% | | 868.33 | Mar. 1, 2003 | | 521000.00 | 2.000% |
| 716.08 | 2.000% | | 1.19 | Mar. 1, 2003 | | 716.08 | 2.000% | | 1.19 | Mar. 1, 2003 | | 716.08 | 2.000% |
| 521000.00 | 2.000% | | 868.33 | Apr. 1, 2003 | | 521000.00 | 2.000% | | 868.33 | Apr. 1, 2003 | | 521000.00 | 2.000% |
| 44.33 | 2.000% | | 0.07 | Apr. 1, 2003 | | 44.33 | 2.000% | | 0.07 | Apr. 1, 2003 | | 44.33 | 2.000% |
| 516000.00 | 2.000% | | 860.00 | May 1, 2003 | | 516000.00 | 2.000% | | 860.00 | May 1, 2003 | | 516000.00 | 2.000% |
| 307.63 | 2.000% | | 0.51 | May 1, 2003 | | 307.63 | 2.000% | | 0.51 | May 1, 2003 | | 307.63 | 2.000% |
| 516000.00 | 2.000% | | 860.00 | Jun. 1, 2003 | | 516000.00 | 2.000% | | 860.00 | Jun. 1, 2003 | | 516000.00 | 2.000% |
| 84.62 | 2.000% | | 0.14 | Jun. 1, 2003 | | 84.62 | 2.000% | | 0.14 | Jun. 1, 2003 | | 84.62 | 2.000% |
| 514000.00 | 2.000% | | 856.67 | Jul. 1, 2003 | | 514000.00 | 2.000% | | 856.67 | Jul. 1, 2003 | | 514000.00 | 2.000% |
| 762.05 | 2.000% | | 1.27 | Jul. 1, 2003 | | 762.05 | 2.000% | | 1.27 | Jul. 1, 2003 | | 762.05 | 2.000% |
| 511000.00 | 2.000% | | 851.67 | Aug. 1, 2003 | | 511000.00 | 2.000% | | 851.67 | Aug. 1, 2003 | | 511000.00 | 2.000% |
| 894.41 | 2.000% | | 1.49 | Aug. 1, 2003 | | 894.41 | 2.000% | | 1.49 | Aug. 1, 2003 | | 894.41 | 2.000% |
| 510000.00 | 2.000% | | 850.00 | Sep. 1, 2003 | | 510000.00 | 2.000% | | 850.00 | Sep. 1, 2003 | | 510000.00 | 2.000% |
| 443.35 | 2.000% | | 0.74 | Sep. 1, 2003 | | 443.35 | 2.000% | | 0.74 | Sep. 1, 2003 | | 443.35 | 2.000% |
| 507000.00 | 2.000% | | 845.00 | Oct. 1, 2003 | | 507000.00 | 2.000% | | 845.00 | Oct. 1, 2003 | | 507000.00 | 2.000% |
| 57.72 | 2.000% | 0 | 0.10 | Oct. 1, 2003 | | 57.72 | 2.000% | | 0.10 | Oct. 1, 2003 | | 57.72 | 2.000% |
| 5,694,150.20 | | 526,399.98 | 9,490.25 | | | 5,167,750.22 | | 525,740.47 | 8,612.92 | | | 4,642,009.75 | |

YEAR 1 OF 16 YEARS TOTAL ON SHEET 1

| ++Y | Z | AA | AB | AC | AD | AE | AF | AG | AH | AI | AJ | AK | AL |
|---|---|---|---|---|---|---|---|---|---|---|---|---|---|
| | | | | Feb. 01, 2003 | | | | | | Mar. 01, 2003 | | | |
| MONTH- | MONTH- | CERTIF- | | | | MONTH- | MONTH- | CERTIF- | | | | MONTH- | MONTH- |
| LY | LY | ICATE | | CERTIF- | | LY | LY | ICATE | | CERTIF | | LY | LY |
| PRIN | INT- | MATU- | | ICATE | MON. | PRIN- | INT- | MATU- | | ICATE | MON. | PRIN- | INT- |
| CIPAL | EREST | RITY | | AMOUNT | RATE | CIPAL | EREST | RITY | | AMOUNT | RATE | CIPAL | EREST |
| PAID | PAID | DATE | | ISSUED | PAID | PAID | PAID | DATE | | ISSUED | PAID | PAID | PAID |
| 522000.00 | 870.00 | Feb. 1, 2003 | | | | | | | | | | | |
| 699.56 | 1.17 | Feb. 1, 2003 | | | | | | | | | | | |
| | 868.33 | Mar. 1, 2003 | | 521000.00 | 2.000% | 521000.00 | 868.33 | Mar. 1, 2003 | | | | | |
| | 1.19 | Mar. 1, 2003 | | 716.08 | 2.000% | 716.08 | 1.19 | Mar. 1, 2003 | | | | | |
| | 868.33 | Apr. 1, 2003 | | 521000.00 | 2.000% | | 868.33 | Apr. 1, 2003 | | 521000.00 | 2.000% | 521000.00 | 868.33 |
| | 0.07 | Apr. 1, 2003 | | 44.33 | 2.000% | | 0.07 | Apr. 1, 2003 | | 44.33 | 2.000% | 44.33 | 0.07 |
| | 860.00 | May 1, 2003 | | 516000.00 | 2.000% | | 860.00 | May 1, 2003 | | 516000.00 | 2.000% | | 860.00 |
| | 0.51 | May 1, 2003 | | 307.63 | 2.000% | | 0.51 | May 1, 2003 | | 307.63 | 2.000% | | 0.51 |
| | 860.00 | Jun. 1, 2003 | | 516000.00 | 2.000% | | 860.00 | Jun. 1, 2003 | | 516000.00 | 2.000% | | 860.00 |
| | 0.14 | Jun. 1, 2003 | | 84.62 | 2.000% | | 0.14 | Jun. 1, 2003 | | 84.62 | 2.000% | | 0.14 |
| | 856.67 | Jul. 1, 2003 | | 514000.00 | 2.000% | | 856.67 | Jul. 1, 2003 | | 514000.00 | 2.000% | | 856.67 |
| | 1.27 | Jul. 1, 2003 | | 762.05 | 2.000% | | 1.27 | Jul. 1, 2003 | | 762.05 | 2.000% | | 1.27 |
| | 851.67 | Aug. 1, 2003 | | 511000.00 | 2.000% | | 851.67 | Aug. 1, 2003 | | 511000.00 | 2.000% | | 851.67 |
| | 1.49 | Aug. 1, 2003 | | 894.41 | 2.000% | | 1.49 | Aug. 1, 2003 | | 894.41 | 2.000% | | 1.49 |
| | 850.00 | Sep. 1, 2003 | | 510000.00 | 2.000% | | 850.00 | Sep. 1, 2003 | | 510000.00 | 2.000% | | 850.00 |
| | 0.74 | Sep. 1, 2003 | | 443.35 | 2.000% | | 0.74 | Sep. 1, 2003 | | 443.35 | 2.000% | | 0.74 |
| | 845.00 | Oct. 1, 2003 | | 507000.00 | 2.000% | | 845.00 | Oct. 1, 2003 | | 507000.00 | 2.000% | | 845.00 |
| | 0.10 | Oct. 1, 2003 | | 57.72 | 2.000% | | 0.10 | Oct. 1, 2003 | | 57.72 | 2.000% | | 0.10 |
| 522,699.56 | 7,736.68 | | | 4,119,310.19 | | 521,716.08 | 6,865.52 | | | 3,597,594.11 | | 521,044.33 | 5,995.99 |

YEAR 1 OF 16 YEARS TOTAL ON SHEET

| ++AM | AN | AO | AP | AQ | AR | AS | AT | AU | AV | AW | AX | AY | AZ |
|---|---|---|---|---|---|---|---|---|---|---|---|---|---|
| | | Apr. 01, 2003 | | | | | | May 01, 2003 | | | | | |
| CERTIF- | | | | MONTH- | MONTH- | CERTIF- | | | | MONTH- | MONTH- | CERTIF- | |
| ICATE | | CERTIF- | | LY | LY | ICATE | | CERTIF- | | LY | LY | ICATE | |
| MATU- | | ICATE | MON. | PRIN- | INT- | MATU- | | ICATE | MON. | PRIN- | INT- | MATU- | |
| RITY | | AMOUNT | RATE | CIPAL | EREST | RITY | | AMOUNT | RATE | CIPAL | EREST | RITY | |
| DATE | | ISSUED | PAID | PAID | PAID | DATE | | ISSUED | PAID | PAID | PAID | DATE | |
| Apr. 1, 2003 | | | | | | | | | | | | | |
| Apr. 1, 2003 | | | | | | | | | | | | | |
| May 1, 2003 | | 516000.00 | 2.000% | 516000.00 | 860.00 | May 1, 2003 | | | | | | | |
| May 1, 2003 | | 307.63 | 2.000% | 307.63 | 0.51 | May 1, 2003 | | | | | | | |
| Jun. 1, 2003 | | 516000.00 | 2.000% | | 860.00 | Jun. 1, 2003 | | 516000.00 | 2.000% | 516000.00 | 860.00 | Jun. 1, 2003 | |
| Jun. 1, 2003 | | 84.62 | 2.000% | | 0.14 | Jun. 1, 2003 | | 84.62 | 2.000% | 84.62 | 0.14 | Jun. 1, 2003 | |
| Jul. 1, 2003 | | 514000.00 | 2.000% | | 856.67 | Jul. 1, 2003 | | 514000.00 | 2.000% | | 858.67 | Jul. 1, 2003 | |
| Jul. 1, 2003 | | 762.05 | 2.000% | | 1.27 | Jul. 1, 2003 | | 762.05 | 2.000% | | 1.27 | Jul. 1, 2003 | |
| Aug. 1, 2003 | | 511000.00 | 2.000% | | 851.67 | Aug. 1, 2003 | | 511000.00 | 2.000% | | 851.67 | Aug. 1, 2003 | |
| Aug. 1, 2003 | | 894.41 | 2.000% | | 1.49 | Aug. 1, 2003 | | 894.41 | 2.000% | | 1.49 | Aug. 1, 2003 | |
| Sep. 1, 2003 | | 510000.00 | 2.000% | | 850.00 | Sep. 1, 2003 | | 510000.00 | 2.000% | | 850.00 | Sep. 1, 2003 | |
| Sep. 1, 2003 | | 443.35 | 2.000% | | 0.74 | Sep. 1, 2003 | | 443.35 | 2.000% | | 0.74 | Sep. 1, 2003 | |
| Oct. 1, 2003 | | 507000.00 | 2.000% | | 845.00 | Oct. 1, 2003 | | 507000.00 | 2.000% | | 845.00 | Oct. 1, 2003 | |
| Oct. 1, 2003 | | 57.72 | 2.000% | | 0.10 | Oct. 1, 2003 | | 57.72 | 2.000% | | 0.10 | Oct. 1, 2003 | |
| | | 3,076,549.78 | | 516,307.63 | 5,127.58 | | | 2,560,242.16 | | 516,084.62 | 4,267.07 | | |

YEAR 1 OF 16 YEARS TOTAL ON SHEET

| ++BA | BB | BC | BD | BE | BF | BG | BH | BI | BJ | BK | BL | BM |
|---|---|---|---|---|---|---|---|---|---|---|---|---|
| | Jun. 01, 2003 | | | | | | Jul. 01, 2003 | | | | | |
| | | | MONTH- | MONTH- | CERTIF- | | | | | MONTH- | CERTIF- | |
| | CERTIF- | | LY | LY | ICATE | | CERTIF- | | | LY | ICATE | |
| | ICATE | MON. | PRIN- | INT- | MATU- | | ICATE | MON. | MONTHLY | INT- | MATU- | |
| | AMOUNT | RATE | CIPAL | EREST | RITY | | AMOUNT | RATE | PRINCIPAL | EREST | RITY | |
| | ISSUED | PAID | PAID | PAID | DATE | | ISSUED | PAID | PAID | PAID | DATE | |
| | 514000.00 | 2.000% | 514000.00 | 856.67 | Jul. 1, 2003 | | | | | | | |
| | 762.05 | 2.000% | 762.05 | 1.27 | Jul. 1, 2003 | | | | | | | |
| | 511000.00 | 2.000% | | 851.67 | Aug. 1, 2003 | | 511000.00 | 2.000% | 511000.00 | 851.67 | Aug. 1, 2003 | |
| | 894.41 | 2.000% | | 1.49 | Aug. 1, 2003 | | 894.41 | 2.000% | 894.41 | 1.49 | Aug. 1, 2003 | |
| | 510000.00 | 2.000% | | 850.00 | Sep. 1, 2003 | | 510000.00 | 2.000% | | 850.00 | Sep. 1, 2003 | |
| | 443.35 | 2.000% | | 0.74 | Sep. 1, 2003 | | 443.35 | 2.000% | | 0.74 | Sep. 1, 2003 | |
| | 507000.00 | 2.000% | | 845.00 | Oct. 1, 2003 | | 507000.00 | 2.000% | | 845.00 | Oct. 1, 2003 | |
| | 57.72 | 2.000% | 0 | | Oct. 1, 2003 | | 57.72 | 2.000% | | 0.10 | Oct. 1, 2003 | |
| | 2,044,157.53 | | 514,762.05 | 3,406.93 | | | 1,529,395.48 | | 511,894.41 | 2,548.99 | | |

YEAR 1 OF 16 YEARS TOTAL ON SHEET 1

| ++BN | BO | BP | BQ | BR | BS | BT | BU | BV | BW | BX |
|---|---|---|---|---|---|---|---|---|---|---|
| Aug. 1, 2003 | | | | | | Sep. 1, 2003 | | | | |
| | | MONTH- | MONTH- | CERTIF- | | | | MONTH- | MONTH- | CERTIF- |
| CERTIF- | | LY | LY | ICATE | | CERTIF- | | LY | LY | ICATE |
| ICATE | MON. | PRIN- | INT- | MATU- | | ICATE | MON. | PRIN- | INT- | MATU- |
| AMOUNT | RATE | CIPAL | EREST | RITY | | AMOUNT | RATE | CIPAL | EREST | RITY |
| ISSUED | PAID | PAID | PAID | DATE | | ISSUED | PAID | PAID | PAID | DATE |
| 510000.00 | 2.000% | 510000.00 | 850.00 | Sep. 1, 2003 | | | | | | |
| 443.35 | 2.000% | 443.35 | 0.74 | Sep. 1, 2003 | | | | | | |
| 507000.00 | 2.000% | | 845.00 | Oct. 1, 2003 | | 507000.00 | 2.000% | 507000.00 | 845.00 | Oct. 1, 2003 |
| 57.72 | 2.000% | | 0.10 | Oct. 1, 2003 | | 57.72 | 2.000% | 57.72 | 0.10 | Oct. 1, 2003 |
| 1,017,501.07 | | 510,443.35 | 1,695.84 | | | 507,057.72 | | 507,057.72 | 845.10 | |

Note:
++denotes continuation of the upper table in linear format from left to right

1. A method comprises selling one or more investment certificates issued in a first issuance in exchange for consideration, wherein each of the investment certificates represents a transferable right secured by at least one first pool of documented, monetary obligations, and wherein each of the investment certificates is at least characterized as follows: (i) when first sold, the certificate is sold to at least one purchaser for a principal amount of consideration, and (ii) the certificate includes commitments from an issuer of the certificate to repay the principal amount of consideration to the at least one purchaser, or a permitted transferee of the at least one purchaser, only upon the occurrence of a fixed maturity date and to make periodic payments of interest only from a selected date until the fixed maturity date, which interest accrues upon the principal amount of consideration at an interest rate specified when the certificate is first sold.

2. The method of claim 1, wherein all of the monetary obligations in the at least one first pool are of like kind.

3. The method of claim 2, wherein the monetary obligations are mortgages.

4. The method of claim 1 further comprising the step of managing the at least one first pool of documented, monetary obligations to maintain a cash flow generated by the pool(s) sufficiently to provide at least enough cash to enable the payment of all interest payments and the principal amount of money due under the investment certificates to the purchasers thereof.

5. The method of claim 4, wherein all of the monetary obligations in the at least one first pool are of like kind.

6. The method of claim 5, wherein the monetary obligations are mortgages.

7. The method of claim 4 wherein the step of managing the at least one first pool is carried out by a process comprising categorizing the cash flow stream of each documented obligation within the at least one first pool relative to all of the other documented obligations within the at least one first pool; removing from the at least one first pool all obligations within the at least one first pool which become non-performing on a cash flow basis, and, for each non-performing monetary obligation removed from the at least one first pool, substituting a substitute documented, monetary obligation which is of like kind to that of the respective non-performing monetary obligation at a time prior to non-performance, wherein the substitute monetary obligation when so substituted provides a cash flow stream at the time of substitution substantially equal to or greater than that of the non-performing obligation for which it is a substitute.

8. The method of claim 7, wherein all of the monetary obligations in the at least one first pool are of like kind.

9. The method of claim 8, wherein the monetary obligations are mortgages.

10. The method of claim 7 wherein the step of managing further comprises establishing a secondary pool of like kind, documented, monetary obligations from income derived from the first pool(s) so as to provide a ready source for substitute documented, monetary obligations.

11. The method of claim 7, wherein the step of managing further comprises borrowing principal from the funds generated by a separate issuance of one or more investment certificates, wherein each of the investment certificates in the separate issuance also represents a transferable right secured by at least one first pool of documented, monetary obligations, and wherein each of the investment certificates in the separate issuance is at least characterized as follows: (i) when first sold, the certificate is sold to at least one purchaser for a principal amount of consideration, and (ii) the certificate includes commitments from an issuer of the certificate to repay the principal amount of consideration to the at least one purchaser, or a permitted transferee of the at least one purchaser, only upon the occurrence of a fixed maturity date and to make periodic payments of interest only from a selected date until the fixed maturity date, which interest accrues upon the principal amount of consideration at an interest rate specified when the certificate is first sold; wherein said borrowing is consummated in a sufficient amount so as to insure that the issuer can meet its monetary obligations when one or more of the substituted, documented obligations bears interest at a rate lower than that of the respective non-performing monetary obligations for which they serve as a substitute.

12. A method comprises issuing one or more investment certificates to be sold to one or more purchasers, wherein each of the investment certificates represents a transferable right secured by at least one first pool of documented, monetary obligations, and wherein each of the investment certificates is at least characterized as follows: (i) when first sold, the certificate is sold to at least one purchaser for a principal amount of consideration, and (ii) the certificate includes commitments from the issuer of the certificate to repay the principal amount of consideration to the at least one purchaser, or a permitted transferee of the at least one purchaser, only upon the occurrence of a fixed maturity date and to make periodic payments of interest only from a selected date until the fixed maturity date, which interest accrues upon the principal amount of consideration at an interest rate specified when the certificate is first sold.

13. The method of claim 12, wherein all of the monetary obligations in the at least one first pool are of like kind.

14. The method of claim 13, wherein the monetary obligations are mortgages.

15. The method of claim 12 further comprising the step of managing the at least one first pool of documented, monetary obligations to maintain a cash flow generated by the pool(s) sufficiently to provide at least enough cash to enable the payment of all interest payments and the principal amount of money due under the investment certificates to the purchasers thereof.

16. The method of claim 15, wherein all of the monetary obligations in the at least one first pool are of like kind.

17. The method of claim 16, wherein the monetary obligations are mortgages.

18. The method of claim 15 wherein the step of managing the at least one first pool is carried out by a process comprising categorizing the cash flow stream of each documented obligation within the at least one first pool relative to all of the other documented obligations within the at least one first pool, removing from the at least one first pool all obligations within the at least one first pool which become non-performing on a cash flow basis, and, for each non-performing monetary obligation removed from the at least one first pool, substituting a substitute documented, monetary obligation which is of like kind to that of the respective non-performing monetary obligation at a time prior to non-performance, wherein the substitute monetary obligation when so substituted provides a cash flow stream at the time of substitution substantially equal to or greater than that of the non-performing obligation for which it is a substitute.

19. The method of claim 18, wherein all of the monetary obligations in the at least one first pool are of like kind.

20. The method of claim 19, wherein the monetary obligations are mortgages.

21. The method of claim 18 wherein the step of managing further comprises establishing a secondary pool of like kind, documented, monetary obligations from income derived from the at least one first pool so as to provide a ready source for substitute documented, monetary obligations.

22. The method of claim 18, wherein the step of managing further comprises borrowing principal from the funds generated by a separate issuance of one or more investment certificates, wherein each of the investment certificates in the separate issuance also represents a transferable right secured by at least one first pool of documented, monetary obligations, and wherein each of the investment certificates in the separate issuance is at least characterized as follows: (i) when first sold, the certificate is sold to at least one purchaser for a principal amount of consideration, and (ii) the certificate includes commitments from an issuer of the certificate to repay the principal amount of consideration to the at least one purchaser, or a permitted transferee of the at least one purchaser, only upon the occurrence of a fixed maturity date and to make periodic payments of interest only from a selected date until the fixed maturity date, which interest accrues upon the principal amount of consideration at an interest rate specified when the certificate is first sold; wherein said borrowing is consummated in a sufficient amount so as to insure that the issuer can meet its monetary obligations when one or more of the substituted, documented obligations bear interest at a rate lower than that of the respective non-performing monetary obligations for which they serve as a substitute.
